(19) United States
(12) Patent Application Publication
(10) Pub. No.: US 2026/0206087 A1
(43) Pub. Date: Jul. 16, 2026

(54) FAST SERVING CELL CHANGE FOR A UE

(71) Applicant: GOOGLE LLC, Mountain View, CA (US)

(72) Inventor: Chih-Hsiang Wu, Taoyuan City (TW)

(21) Appl. No.: 19/114,323

(22) PCT Filed: Sep. 23, 2023
(86) PCT No.: PCT/US2023/033562

§ 371 Date: Mar. 21, 2025

Related U.S. Application Data
(60) Provisional application No. 63/409,700, filed on Sep. 23, 2022.
(60) Provisional application No. 63/377,049, filed on Sep. 25, 2022.

(51) Int. Cl. H04W 76/19; H04W 74/0833

(52) U.S. Cl. CPC H04W 76/19; H04W 74/0833

(57) ABSTRACT

A user equipment (UE) receives, from a radio access network (RAN) in a serving cell, a delta configuration related to a target cell, for use in accessing the target cell subsequent to an activation command; receives, from the RAN, an activation command related to the delta configuration; and in response to the activation command the RAN, uses the delta configuration and at least a portion of a prior configuration to begin communicating on the target cell.

### CROSS-REFERENCE TO RELATED APPLICATIONS

This application claims priority to and the benefit of the filing date of provisional U.S. Patent Application No. 63/409,683 entitled “FAST SERVING CELL CHANGE FOR A UE,” filed on Sep. 23, 2022 and U.S. Patent Application No. 63/377,049 entitled “FAST SERVING CELL CHANGE FOR A UE,” filed on Sep. 25, 2022. The entire contents of the provisional applications are hereby expressly incorporated herein by reference.

### FIELD OF THE DISCLOSURE

This disclosure relates to wireless communications and, more particularly, to enabling a fast serving cell change for a user equipment (UE).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, in some scenarios, the UE and a base station use SRBs to exchange RRC messages as well as non-access stratum (NAS) messages. In further scenarios, the UE and base station use DRBs to transport data on a user plane.

Depending on the scenario, UEs use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN and can be referred to as MCG SRBs. SRB3 resources allow the UE and the SN to exchange RRC messages related to the SN and can be referred to as SCG SRBs. Split SRBs allow the UE to exchange RRC messages directly with the MN via lower layer resources of the MN and the SN. Further, DRBs using the lower-layer resources of only the MN can be referred as MCG DRBs, DRBs using the lower-layer resources of only the SN can be referred as SCG DRBs, and DRBs using the lower-layer resources of both the MCG and the SCG can be referred to as split DRBs.

The UE, in some scenarios, concurrently utilizes resources of multiple radio access network (RAN) nodes (e.g., base stations or components of a distributed base station), interconnected by a backhaul. When such network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE utilizes resources of one base station at a time. One base station and/or the UE determine that the UE should establish a radio connection with another base station. For example, one base station determines to hand the UE over to the second base station and initiates a handover procedure.

When the UE moves from coverage area of one cell to another cell in a RAN, at some point a serving cell change will be performed for the UE. To perform the serving cell change, the RAN configures the UE to transmit Layer 3 (L3) measurement results. Based on L3 measurement results received from the UE, the RAN transmits an RRC reconfiguration message configuring Reconfiguration with Synchronization (e.g., the RRC reconfiguration message includes a ReconfigurationWithSync IE) for change of the serving cell (e.g., PCell or PSCell). In cases where the UE operates in carrier aggregation (CA) of at least one secondary cell (SCell) with the PCell or PSCell, the RAN has to release the at least one SCell due to the change of the PCell or PSCell. The serving cell change involves complete L2 (and L1) resets, leading to longer latency, larger overhead, and longer interruption time. Thus, it is desirable to develop new mobility techniques to reduce latency and overhead for the serving cell change. However, it is not clear how to reduce latency and overhead for the serving cell change.

### SUMMARY

An example implementation of the techniques of this disclosure is a method in a user equipment (UE). The method includes receiving, from a radio access network (RAN) in a serving cell, a delta configuration related to a target cell, for use in accessing the target cell subsequent to an activation command; receiving, from the RAN, an activation command related to the delta configuration; and in response to the activation command the RAN, using the delta configuration and at least a portion of a prior configuration to begin communicating on the target cell.

Another example implementation of these techniques is a user equipment (UE) comprising: a transceiver; and processing hardware configured to implement a method of any of the preceding claims.

Another example implementation of the techniques is a method in a radio access network (RAN), the method comprising: transmitting, to a user equipment (UE) a serving cell, a delta configuration related to a target cell, for use in accessing the target cell subsequent to an activation command; transmitting, to the UE, an activation command related to the delta configuration; and communicating with the UE in the target cell according to the delta configuration and at least a portion of a prior configuration.

Still another example implementation of these techniques is a radio access network (RAN) comprising: a transceiver; and processing hardware configured to implement a method of claim 13 or 14.

### BRIEF DESCRIPTION OF THE DRAWINGS

FIG. 1A is a block diagram of an example system in which a radio access network (RAN) and a user device can implement the techniques of this disclosure for managing conditional procedures related to a secondary node (SN);

FIG. 1B is a block diagram of an example base station including a centralized unit (CU) and a distributed unit (DU) that can operate in the system of FIG. 1A;

FIG. 2 is a block diagram of an example protocol stack according to which the UE of FIG. 1A communicates with base stations;

FIG. 3 is a messaging diagram of an example scenario where a base station configures a UE to perform a lower layer procedure for a cell change operation;

FIG. 4A is a messaging diagram of an example scenario where an MN operates in DC with an SN to perform a lower layer procedure for a cell change operation;

FIG. 4B is a messaging diagram of an example scenario similar to that of FIG. 4A, but in which the MN configures the UE directly;

FIG. 5A is a flow diagram depicting an example method, implemented in a RAN node, in which the RAN node transmits a configuration and a configuration activation command to a UE before transmitting a second configuration activation command to the UE;

FIG. 5B is a flow diagram depicting an example method similar to that of FIG. 5A, but in which the RAN node releases the remaining configurations;

FIG. 6A is a flow diagram depicting an example method, implemented in a RAN node, in which the RAN node determines whether to include a configuration in a container based on whether the application of the configuration is to be triggered by a configuration activation command;

FIG. 6B is a flow diagram depicting an example method similar to that of FIG. 6A, but in which the RAN node transmits the configuration to the UE rather than transmitting a message including the configuration;

FIG. 7 is a flow diagram depicting an example method, implemented in a RAN node, in which the RAN node transmits lists of configurations and IDs to a UE;

FIG. 8 is a flow diagram depicting an example method, implemented in a RAN node, in which the RAN node a first or second ID and configuration to the UE by the MN or the SN;

FIG. 9 is a flow diagram depicting an example method, implemented in a RAN node, in which the RAN node transmits configurations and ID(s) to a UE via a first cell and a configuration activation command before communicating with the UE on a second cell;

FIG. 10 is a flow diagram depicting an example method, implemented in a RAN node, in which the RAN node determines whether to transmit ID(s) and configuration(s) to the UE with a value within a first or second range based on whether the RAN node operates as an MN for the UE;

FIG. 11A is a flow diagram depicting an example method, implemented in a UE, in which the UE receives a configuration and a configuration activation command from a RAN via a first or second cell;

FIG. 11B is a flow diagram depicting an example method similar to that of FIG. 11A, but in which the UE releases remaining configurations after receiving the activation command;

FIG. 12 is a flow diagram depicting an example method, implemented in a UE, in which the UE determines whether to identify or discard a configuration based on whether a first ID is included in the ID(s) received from the RAN;

FIG. 13 is a flow diagram depicting an example method, implemented in a UE, in which the UE determines whether to immediately apply or store a configuration based on whether the UE receives the configuration in a particular IE;

FIG. 14 is a flow diagram depicting an example method, implemented in a UE, in which the UE receives a first and third list of configurations from the RAN and releases configurations on the third list;

FIG. 15 is a flow diagram depicting an example method, implemented in a UE, in which the UE receives a first or second ID and configuration from the MN or SN;

FIG. 16A is a flow diagram depicting an example method, implemented in a UE, in which the UE identifies a configuration from a first or second configuration based on whether the UE receives the configuration activation command from the MN or SN;

FIG. 16B is a flow diagram depicting an example method similar to that of FIG. 16A, but in which the UE further determines whether the first ID is included in a first or second set of ID(s);

FIG. 17 is a flow diagram depicting an example method, implemented in a RAN node, in which the RAN node transmits a configuration to the UE as a full configuration or a delta configuration;

FIG. 18A is a flow diagram depicting an example method, implemented in a RAN node, in which the RAN node generates a configuration as a full configuration and transmits the configuration and a full configuration indication in a container to the UE;

FIG. 18B is a flow diagram depicting an example method similar to that of FIG. 18A, but in which the RAN node generates the configuration including the full configuration indication;

FIG. 19A is a flow diagram depicting an example method, implemented in a RAN node, in which the RAN node generates a container excluding an indication of a delta configuration;

FIG. 19B is a flow diagram depicting an example method similar to that of FIG. 19A, but in which the RAN node excludes the indication in the second configuration;

FIG. 20 is a flow diagram depicting an example method, implemented in a RAN node, in which the RAN node determines whether to generate the second configuration as a full or delta configuration based on whether the second configuration is to replace the first configuration;

FIG. 21 is a flow diagram depicting an example method, implemented in a RAN node, in which the RAN node communicates with the UE using the second configuration or the second configuration and a portion of the first configuration based on whether the RAN node transmits an indication that the second configuration is a full configuration;

FIG. 22 is a flow diagram depicting an example method, implemented in a RAN node, in which the RAN node transmits a message and an indication that a first IE is or includes a full configuration;

FIG. 23 is a flow diagram depicting an example method, implemented in a RAN node, in which the RAN node releases a portion or entirety of a plurality of configuration parameters based on whether a message includes a first or second indication;

FIG. 24 is a flow diagram depicting an example method, implemented in a RAN node, in which the RAN node communicates with a UE using a portion of a first configuration in addition to a second configuration based on whether the second configuration is for later activation;

FIG. 25A is a flow diagram depicting an example method, implemented in a UE node, in which the UE receives a full configuration or a delta configuration from a RAN node;

FIG. 25B is a flow diagram depicting an example method similar to that of FIG. 25A, but in which the UE determines whether to communicate with the RAN node using a portion of a first configuration in addition to a second configuration based on which configuration a configuration activation command activates;

FIG. 26A is a flow diagram depicting an example method, implemented in a UE node, in which the UE receives a message including a container IE from a RAN including a configuration and an indication that the configuration is a full configuration;

FIG. 26B is a flow diagram depicting an example method similar to that of FIG. 26A, but in which the second configuration includes the indication;

FIG. 27A is a flow diagram depicting an example method, implemented in a UE node, in which the UE receives a container including a configuration and excluding an indication that the configuration is a delta configuration;

FIG. 27B is a flow diagram depicting an example method similar to that of FIG. 27A, but in which the second configuration excludes the indication;

FIG. 28 is a flow diagram depicting an example method, implemented in a UE node, in which the UE determines whether to communicate with a RAN using a portion of a first configuration in addition to a second configuration based on whether the UE receives an indication that the second configuration is a full configuration; and

FIG. 29 is a flow diagram depicting an example method, implemented in a UE node, in which the UE determines whether to release an entirety or portion of a plurality of configuration parameters based on whether a message includes a first or second indication.

### DETAILED DESCRIPTION OF THE DRAWINGS

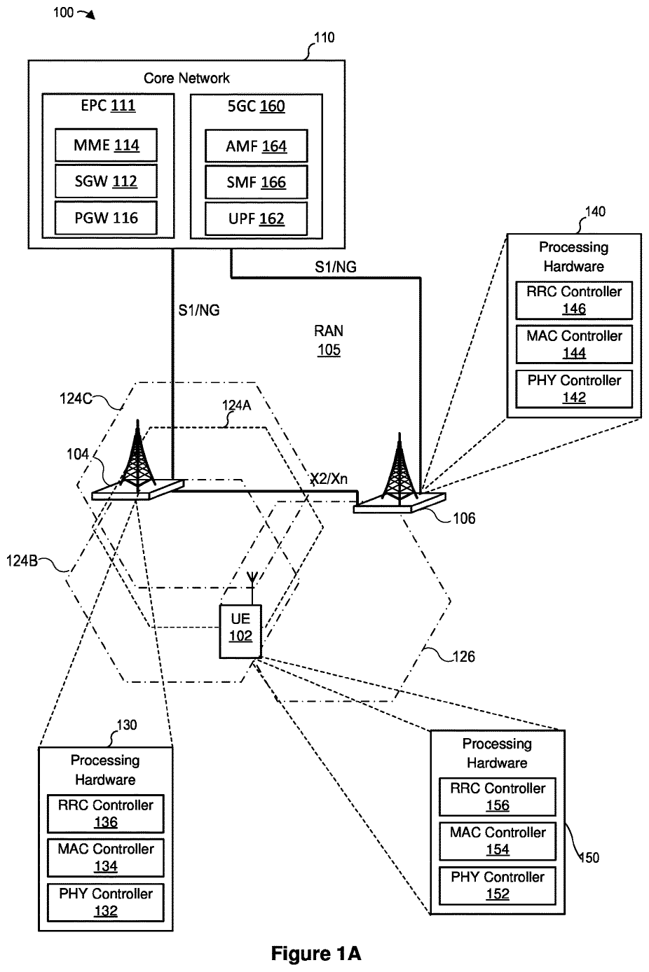

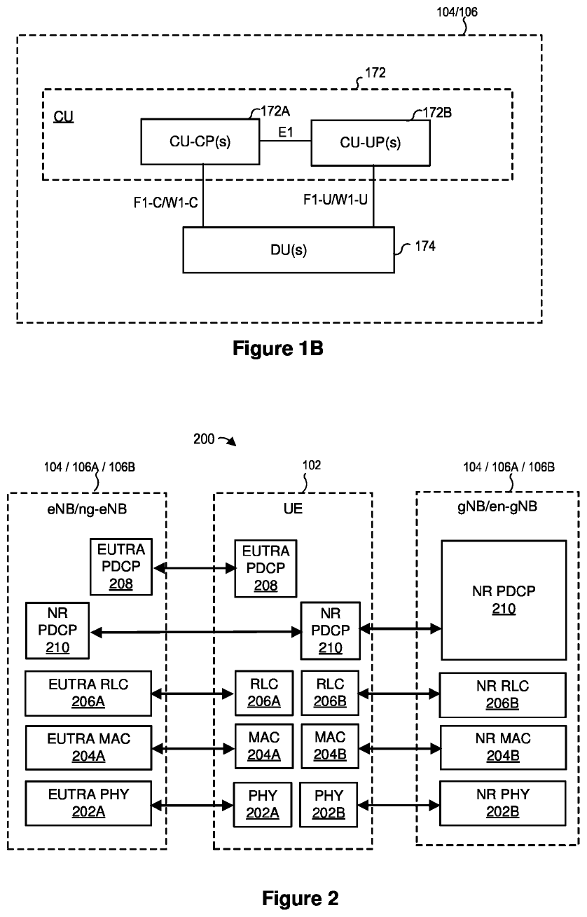

FIG. 1A depicts an example wireless communication system 100 in which communication devices can implement these techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cell 124A, and the base station 106 supports a cell 126. The cells 124A and 126 can partially overlap, so that the UE 102 can communicate in DC with the base station 104 and the base station 106, where one of the base stations 104 and 106 is an MN and the other is an SN. The base station 104 can support additional cell(s) such as cells 124B and 124C, and the base station 106 can support additional cell(s) (not shown in FIG. 1A). The cells 124A, 124B and 124C can partially overlap, so that the UE 102 can communicate in carrier aggregation (CA) with the base station 104. The base station 104 can operate the cells 124A, 124B and 124C via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g. UE 102) via one or more cells (e.g., the cell(s) 124A, 124B and/or 124C) and/or one or more TRPs. The PHY controller 132 is also configured to receive data and control signal on physical uplink (UL) channels and/or UL reference signals with the one or more user devices via one or more cells (e.g., the cell(s) 124A, 124B and/or 124C) and/or one or more TRPs. The processing hardware 130 in an example implementation includes a MAC controller 134 configured to perform MAC functions with one or more user devices. The MAC functions includes a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells (e.g., the cell(s) 124A, 124B, 124C and/or 126) and/or one or more TRPs. The PHY controller 152 is also configured to transmit data and control signal on physical UL channels and/or UL reference signals with the base station 104 or 106 via one or more cells (e.g., the cell(s) 124A, 124B, 124C and/or 126) and/or one or more TRPs. The processing hardware 150 in an example implementation includes a MAC controller 154 configured to perform MAC functions with base station 104 or 106. For example, the MAC functions includes a random access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller 142 configured to manage or control one or more RRC configurations and/or RRC procedures when the base station 106 operates as an SN. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106 operates as an MN or an SN. The process hardware may include further a physical layer controller configured to manage or control one or more physical layer operations or procedures.

Next, FIG. 2 illustrates in a simplified manner a radio protocol stack according to which the UE 102 can communicate with an eNB/ng-eNB or a gNB. Each of the base stations 104 or 106 can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE 102 operates in EUTRA/NR DC (EN-DC), with the base station 104 operating as a MeNB and the base station 106 operating as a SgNB, the network can provide the UE 102 with an MN-terminated bearer that uses EUTRA PDCP 208 or MN-terminated bearer that uses NR PDCP 210. The network in various scenarios also can provide the UE 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

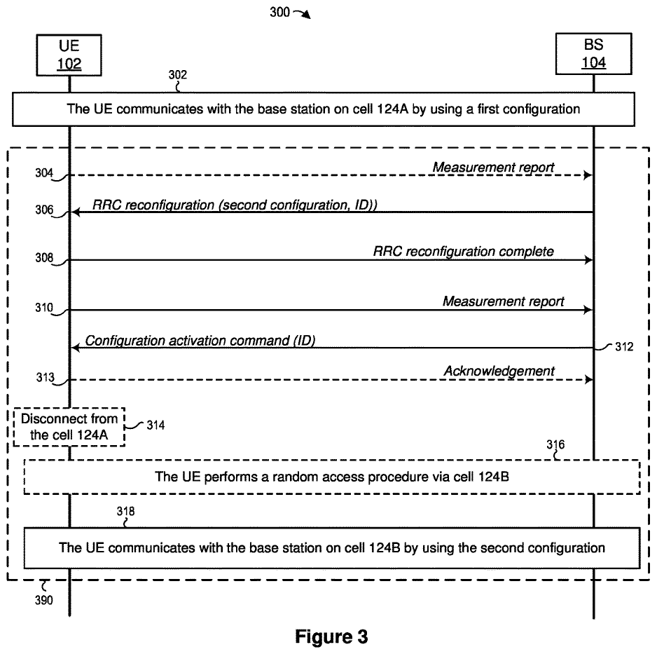

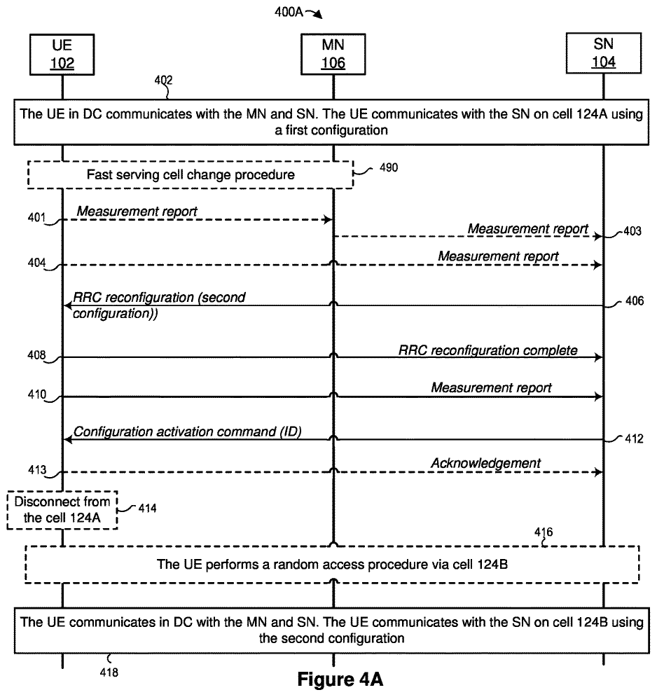

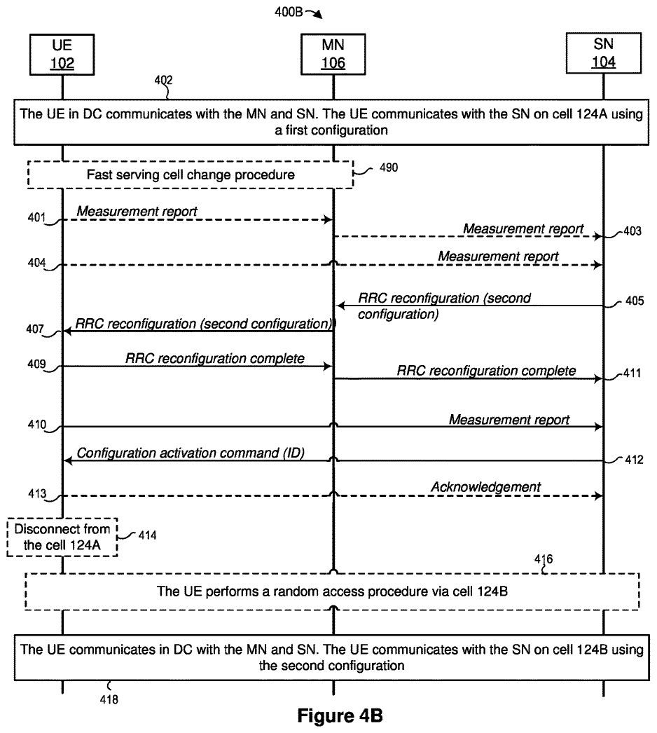

Next, several example scenarios in which the base station operating in the system of FIG. 1A transmits a configuration to the UE 102 and later activates the configuration for communication between the UE 102 and base station. Generally speaking, events in FIGS. 3, 4A, and 4B that are similar are labeled with similar reference numbers (e.g., event 316 is similar to event 416 of FIGS. 4A and 4B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the UE 102 initially communicates 302 with the base station 104 on cell 124A. In some implementations, the UE 102 in carrier aggregation (CA) communicates with the base station 104 on the cell 124A and other cell(s) using the first configuration. In other implementations, the UE 102 communicates with the base station 104 on the cell 124A only. In some implementations, the UE 102 communicates with the base station 104 on the cell 124A and/or other cell(s) via one or multiple TRPs. In some implementations, the cell 124A is a PCell. In such cases, the other cell(s) include SCell(s) and/or additional cell(s) associated with the PCell or an SCell. In other implementations, the cell 124A is an SCell, and one of the other cell(s) is a PCell. In such cases, the rest includes SCell(s) and/or additional cell(s) associated with the PCell or an SCell.

In some implementations, in the event 302, the UE 102 transmits UL PDUs and/or UL control signals to the base station 104 on the cell 124A and/or other cell(s) via one or multiple TRPs. In some implementations, the UE 102 communicates UL PDUs and/or DL PDUs with the base station 104 via radio bearers which can include SRBs and/or DRB(s). In further implementations, the base station 104 configures the radio bearers for the UE 102. In some implementations, UL control signals include UL control information, channel state information, hybrid automatic repeat request (HARQ) acknowledgements (ACKs), HARQ negative ACKs, scheduling request(s), and/or sounding reference signal(s). Similarly, in further implementations, the UE 102 receives DL PDUs and/or DL control signals from the base station 104 on the cell 124A and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). In further implementations, the base station 104 transmits the DCIs on physical downlink control channel(s) (PDCCH(s)) monitored by the UE 102, on the cell 124A and/or other cell(s) via one or multiple TRPs.

In some implementations, the first configuration includes physical layer configuration parameters, MAC configuration parameters, RLC configuration parameters, PDCP configuration parameters, measurement configuration parameters, and/or radio bearer configuration parameters. In some implementations, the first configuration includes a CellGroupConfig IE (e.g., defined in 3GPP specification 38.331) or configuration parameters in the CellGroupConfig IE. In some implementations, the first configuration includes a CSI-MeasConfig IE, a MeasConfig IE, and/or a RadioBearerConfig IE (e.g., as defined in 3GPP specification 38.331) or includes configuration parameters in the CSI-MeasConfig IE, MeasConfig IE, and/or RadioBearerConfig IE. In some implementations, the UE 102 receives the configuration parameters from the base station 104. In other implementations, the UE 102 receives a portion of the configuration parameters from a base station other than the base station 104 and the remaining portion of the configuration parameters from the base station 104.

While communicating with the base station 104, the UE 102 transmits 304 at least one measurement report to the base station 104. In some implementations, the at least one measurement report includes Layer 1 (L1) measurement report(s) and/or Layer 3 (L3) measurement report(s) for at least one serving cell of the UE 102 and/or at least one non-serving cell. The at least one serving cell includes the cell 124A and/or other cell(s) (e.g., cell 124D not shown in FIG. 1A), and the at least one non-serving cell includes the cell 124B and/or cell 124C. In some implementations, the first configuration includes at least one measurement configuration configuring the UE 102 to perform measurements and report measurement results. In some implementations, the UE 102 receives one or more RRC messages (e.g., RRCReconfiguration message(s)) including the at least one measurement configuration from the base station 104 in the event 302. In accordance with the at least one measurement configuration, the UE 102 performs measurements and transmits 304 the at least one measurement report to the base station 104. In some implementations, the at least one measurement configuration includes L3 measurement configuration(s) (e.g., MeasConfig IE(s)) and/or L1 measurement configuration(s). For example, the L1 measurement configuration(s) (e.g., CSI-MeasConfig IE(s)) includes CSI resource configuration(s) (e.g., CSI-ResourceConfig IE(s)) and/or CSI reporting configuration (e.g., CSI-ReportConfig IE(s)). The UE 102 transmits the L3 measurement report(s) to the base station 104 in accordance with the L3 measurement configuration(s). The UE 102 transmits the L1 measurement report(s) to the base station 104 in accordance with the L1 measurement configuration(s). In some implementations, the at least one measurement configuration includes new-type measurement configuration(s) (e.g., new RRC IE(s) (e.g., defined in 3GPP specification 38.331 v18.0.0 and/or later version(s))) for the fast serving cell change. For example, the new-type measurement configuration(s) includes CSI resource configuration(s) (e.g., CSI-ResourceConfig IE(s)) and/or new-type reporting configuration(s). In such implementations, the at least one measurement report includes new-type measurement report(s) associated with the new-type measurement configuration(s). The UE 102 transmits the new-type measurement report(s) to the base station 104 in accordance with the new-type measurement configuration(s). In some implementations, each of the new-type reporting configuration(s) includes a trigger event configuration configuring a trigger event to trigger the UE 102 to transmit a new-type measurement report. If the UE 102 detects the trigger event, the UE 102 transmits a new-type measurement report to the base station 104. In this disclosure, “new-type” can refer to specific definition of a message, information element, data structure, etc. for the specific purpose of supporting fast cell change functionality.

In some implementations, the L1 measurement report(s) include at least one L1 measurement result. In some implementations, the at least L1 measurement result includes at least one L1-reference signal received power (L1-RSRP) value and/or at least one L1-Signal to Interference Noise Ratio (L1-SINR) value. In some implementations, for each of the L1 measurement report(s), the UE 102 transmits a PUCCH transmission including the L1 measurement report to the base station 104. That is, the UE 102 transmits each of the L1 measurement report(s) on a PUCCH to the base station 104. In other implementations, for each of the L1 measurement report(s), the UE 102 transmits a PUSCH transmission, including the L1 measurement report, to the base station 104. That is, the UE 102 transmits each of the L1 measurement report(s) on a PUSCH to the base station 104. In yet other implementations, the UE 102 transmits a portion of the L1 measurement report(s) on PUCCH(s) and the rest of the L1 measurement report(s) on physical UL shared channel(s) (PUSCH(s)) to the base station 104. That is, for each of the portions of the L1 measurement report(s), the UE 102 transmits a PUCCH transmission, including the L1 measurement report, to the base station 104, and for each of the rest of the L1 measurement report(s), the UE 102 transmits a PUSCH transmission, including the L1 measurement report, to the base station 104. In some implementations, each of the L1 measurement report(s) is a part of channel state information (CSI) (i.e., a CSI component) or CSI. In some implementations, the UE 102 includes other CSI component(s) in the PUCCH transmission(s) and/or PUSCH transmission(s) described above. In some implementations, the other CSI component(s) include such as a channel quality indicator (CQI), a Precoding Matrix Indicator (PMI), a CSI-RS Resource Indicator (CRI), a Synchronization Signal (SS)/Physical Broadcast Channel (PBCH) Resource Block Indicator (SSBRI), a Layer Indicator (LI), and/or a Rank Indicator (RI).

In some implementations, each of the L3 measurement report(s) can include at least one L3 measurement result. In some implementations, the at least one L3 measurement result includes at least one RSRP (value) and/or at least one SINR (value). In some implementations, the UE 102 transmits each of the L3 measurement report(s) on a PUSCH to the base station 104. In some implementations, each of the L3 measurement report(s) is an RRC message (e.g., MeasurementReport message). In some implementations, each of the L3 measurement configuration(s) includes a particular measurement identity (e.g., measId), and each of the L3 measurement report(s) includes a particular measurement identity in a particular L3 measurement configuration. In further implementations,hen the base station 104 receives a nL3 measurement report including a measurement identity and an L3 measurement result from the UE 102, the base station 104 determines that the L3 measurement report is associated to an L3 measurement configuration identified by the measurement identity.

In some alternative implementations, for each of the at least one measurement report (e.g., L1 measurement report(s), L3 measurement report(s), and/or new-type measurement report(s)), the UE 102 transmits a MAC control element (CE) including the measurement report to the base station 104 in the event 304. To transmit the MAC CE(s), the UE 102 generates one or more MAC PDUs, each including one or more of the MAC CE(s), for the base station 104 in the event 304.

In some implementations, the UE 102 performs measurements on one or more reference signals in accordance with the at least one measurement configuration. Depending on the implementation, the one or more reference signals include one or more Synchronization Signal (SS)/Physical Broadcast Channel (PBCH) Resource Blocks (SSBs) and/or one or more CSI-RSs. The UE 102 obtains the at least one L1 measurement result and/or at least one L3 measurement result from the measurements. The base station 104 transmits the one or more reference signals on the cells 124A and 124B, and, in further implementations, the cell 124C and/or other cell(s).

After (e.g., in response to) receiving one or some of the at least one measurement report in the event 304, the base station 104 determines to prepare the cell 124B for the UE 102. In some implementations, the base station 104 determines to prepare the cell 124B for the UE 102 because the at least one measurement report indicates that the cell 124B could be used by the base station 104 to communicate with the UE 102. For example, if the at least one measurement report indicates that signal strength and/or quality of the cell 124B is above a first predetermined threshold and/or is better (e.g., higher) than the cell 124A, the base station 104 determines to prepare the cell 124B for the UE 102. Alternatively, the base station 104 determines to prepare the cell 124B for the UE 102 regardless of whether a measurement report is received from the UE 102 or not.

In response to the determination to prepare the cell 124B, the base station 104 generates a second configuration (referred to herein as configuration 1) configuring the cell 124B, generates an RRC reconfiguration message (e.g., an RRCReconfiguration message) including the configuration 1, and transmits 306 the RRC reconfiguration message to the UE 102. In response, the UE 102 transmits 308 an RRC reconfiguration complete message (e.g., an RRCReconfigurationComplete message) to the base station 104. In some implementations, the base station 104 performs security protection (e.g., integrity protection and/or encryption) on the RRC reconfiguration message. For example, the base station 104 generates a message authentication code for integrity (MAC-I) for the RRC reconfiguration message, encrypts the RRC reconfiguration message and the MAC-I to obtain an encrypted RRC reconfiguration message and an encrypted MAC-I, and transmits a PDCP PDU including the encrypted RRC reconfiguration message and encrypted MAC-I to the UE 102 in the event 306. When the UE 102 receives the PDCP PDU from the base station 104 in the event 306, the UE 102 decrypts the encrypted RRC reconfiguration and encrypted MAC-I to obtain the RRC reconfiguration message and MAC-I, and verifies whether the MAC-I is valid. If the UE 102 verifies the MAC-I is invalid, the UE 102 discards or ignores the RRC reconfiguration message. In some implementations, the UE 102 performs an RRC connection reestablishment procedure in response to the invalid MAC-I. Otherwise, in some implementations, if the UE 102 verifies the MAC-I is valid, the UE 102 processes the RRC reconfiguration. The UE 102 refrains from applying (i.e., executing) the configuration 1 until receiving a configuration activation command activating the configuration 1 (e.g., the event 312).

In some implementations, the base station 104 includes a field or an IE (e.g., as defined in 3GPP specification 38.331 v18.0.0 and/or later versions, 3GPP 6G specification, etc.) in the RRC reconfiguration message of the event 306 to indicate to the UE 102 not to apply the configuration 1 immediately. In some implementations, the field or IE is an indicator. If the RRC reconfiguration message of the event 306 includes the indicator, the UE 102 refrains from immediately applying the configuration 1. Otherwise, if the RRC reconfiguration message of the event 306 does not include the indicator, the UE 102 applies the configuration 1 immediately. In other implementations, the field or IE is a container (e.g., the first container and/or second container described below). For example, the UE 102 receives an RRC reconfiguration message (e.g., the RRC reconfiguration message of the event 306), including a configuration (e.g., configuration 1). If the configuration is included in the container, the UE 102 refrains from immediately applying the configuration. Otherwise, if the configuration is not included in the container, the UE 102 applies the configuration immediately.

In some implementations, the base station 104 generates a first container including the configuration 1, includes the first container in the RRC reconfiguration message, and transmits the RRC reconfiguration message to the UE 102 in the event 306. In some implementations, the first container is a first addition or modification list (e.g., ConfigToAddModList IE, CellConfigToAddModList IE, MobilityToAddModList IE, MobilityConfigToAddModList IE, or CellGroupConfigToAddModList IE). The base station 104 includes the configuration 1 in a first element (referred to herein as element 1) of the first addition or modification list. For example, the element 1 can be an addition or modification IE (e.g., ConfigToAddMod IE, CellConfigToAddMod IE, MobilityToAddMod IE, MobilityConfigToAddMod IE, or CellGroupConfigToAddMod IE). In some implementations,hen the UE 102 receives the first addition or modification list, the UE 102 stores the first addition or modification list (e.g., in a variable in the random access memory (RAM)).

In some implementations, the base station 104 includes, in the RRC reconfiguration message, a first ID (referred to herein after as ID 1) for identifying the configuration 1. In some implementations, the base station 104 includes the ID 1 in the first container or element 1. In some implementations, the base station 104 assigns the ID 1 for the configuration 1.

In some implementations, the configuration 1 includes a plurality of configurations for the UE 102 to communicate with the base station 104 on the cell 124B. In some implementations, the plurality of configurations includes physical layer configuration parameters (e.g., PhysicalCellGroupConfig IE), MAC layer configuration parameters (e.g., MAC-CellGroupConfig IE), and/or RLC configuration parameters (e.g., RLC-BearerConfig 1E(s)). In some further implementations, the plurality of configurations includes a special cell configuration (e.g., SpCellConfig IE) and/or one or more SCell configurations (e.g., SCellConfig IE(s)).

In some implementations, the base station 104 includes a random access configuration in the configuration 1. In other implementations, the base station 104 does not include a random access configuration in the configuration 1. In some implementations, if the cell 124A and cell 124B are not synchronized, the base station 104 determines to include the random access configuration in the configuration 1. Otherwise, if the cell 124A and cell 124B are synchronized, the base station 104 determines to not include the random access configuration in the configuration 1. In other implementations, if the base station 104 determines that the UE 102 has not synchronized in UL with the cell 124B, the base station 104 determines to include the random access configuration in the configuration 1. Otherwise, if the base station 104 determines that the UE 102 has synchronized in UL with the cell 124B, the base station 104 determines to not include the random access configuration in the configuration 1. If the configuration 1 includes the random access configuration, the UE 102 performs the random access procedure in the event 316 in accordance with the random access configuration, as described below. Otherwise, if the configuration 1 does not include the random access configuration, the UE 102 skips the random access procedure of the event 316 in response to the configuration 1 excluding the random access configuration.

In some implementations, the base station 104 includes a random access configuration in the configuration 1 regardless of whether the cells 124A and 124B are synchronized or not. In some implementations, if the cell 124A and cell 124B are synchronized, the base station 104 determines to include, in the configuration 1, a first indication configuring the UE 102 not to perform a random access procedure on the cell 124B. Otherwise, if the cell 124A and cell 124B are not synchronized, the base station 104 determines to not include the first indication in the configuration 1. In other implementations, if the base station 104 determines that the UE 102 has synchronized in UL with the cell 124B, the base station 104 determines to include the first indication in the configuration 1. Otherwise, if the base station 104 determines that the UE 102 has not synchronized in UL with the cell 124B, the base station 104 determines to not include the first indication in the configuration 1. If the configuration 1 includes the first indication, the UE 102 skips the random access procedure of the event 316 in accordance with or in response to the first indication. Otherwise, if the configuration 1 does not include the first indication, the UE 102 performs the random access procedure in accordance with the random access procedure in the event 316, in response to the configuration 1 excluding the first indication, as described below.

In some implementations, the base station 104 includes a reconfiguration with sync configuration (e.g., ReconfigurationWithSync IE) in the configuration 1 or special cell configuration. In other implementations, the base station 104 does not include a reconfiguration with sync configuration (e.g., ReconfigurationWithSync IE) in the configuration 1 or special cell configuration. In some implementations, if the cell 124A and cell 124B are not synchronized, the base station 104 determines to include the reconfiguration with sync configuration in the configuration 1. Otherwise, if the cell 124A and cell 124B are synchronized, the base station 104 determines to not include the reconfiguration with sync configuration in the configuration 1. In other implementations, if the base station 104 determines that the UE 102 has not synchronized in UL with the cell 124B, the base station 104 determines to include the reconfiguration with sync configuration in the configuration 1. Otherwise, if the base station 104 determines that the UE 102 has synchronized in UL with the cell 124B, the base station 104 determines to not include the reconfiguration with sync configuration in the configuration 1. In some implementations, if the configuration 1 includes the reconfiguration with sync configuration, the UE 102 performs the random access procedure in the event 316 as described below, in response to or in accordance with the reconfiguration with sync configuration. Otherwise, if the configuration 1 does not include the reconfiguration with sync configuration, the UE 102 skips the random access procedure of the event 316. In some implementations, the base station 104 includes a cell identity (ID) (i.e., cell ID 1) of cell 1 (i.e., the cell 124B) in the configuration 1. In some implementations, the cell ID 1 is a physical cell ID (PCI). In some further implementations, the configuration 1 includes a cell index (e.g., a serving cell index) indexing the cell ID 1 or the cell 124B.

In some implementations, after (e.g., in response to) receiving one or some of the at least one measurement report of the event 304, the base station 104 determines to prepare other cell(s) of the base station 104 for the UE 102. In some implementations, the base station 104 determines to prepare the other cell(s) because the at least one measurement report indicates that the other cell(s) could be used by the base station 104 to communicate with the UE 102. In further implementations, the other cell(s) include the cell 124C and/or cell(s) other than the cells 124A, 124B, and 124C. In some implementations, if the L3 measurement report(s) indicates that signal strength and/or quality of a particular cell of the other cell(s) is above a respective predetermined threshold and/or is better (e.g., higher) than the cell 124A, the base station 104 determines to prepare the particular cell for the UE 102. In other implementations, if the L1 measurement report(s) or new-type measurement report(s) indicates that signal strength and/or quality of a particular cell of the other cell(s) is above a first predetermined threshold and/or is better (e.g., higher) than the cell 124A, the base station 104 determines to prepare the particular cell for the UE 102. In some implementations, the respective predetermined threshold(s) for the other cells are different from the first predetermined threshold. In further implementations, the respective predetermined threshold(s) for the other cell(s) are the same as the first predetermined threshold. In some implementations, the respective predetermined thresholds for the other cells are the same or different. Alternatively, the base station 104 determines to prepare the other cell(s) for the UE 102 regardless of whether a measurement report is received from the UE 102 or not.

In response to the determination to prepare the other cell(s), the base station 104 generates configuration(s) 2, . . . , N, each configuring a particular cell of the base station 104, and includes the configuration(s) 2, . . . , N in the first container. “N” is an integer and larger than one. For example, “N” is 2, 4, 6, 8, 10, 12, 14 or 16. Examples and implementations of the configuration 1 can apply to the configuration(s) 2, . . . , N. In some implementations, the base station 104 assigns ID(s) 2, . . . , N, identifying the configuration(s) 2, . . . , N, respectively, and includes the ID(s) 2, . . . , N in the first container. For example, the base station 104 includes the ID(s) 2, . . . , N and configuration(s) 2, . . . , N in element(s) 2, . . . , N in the first addition or modification list. In some alternative implementations, the base station 104 generates a second container including the configuration(s) 2, . . . , N or element(s) 2, . . . , N instead of using the first container. The base station 104 then transmits an additional RRC reconfiguration message, including the second container, to the UE 102. In response, the UE 102 transmits an additional RRC reconfiguration complete message to the base station 104.

In some implementations, the second container is a second addition or modification list (e.g., ConfigToAddModList IE, CellConfigToAddModList IE, MobilityToAddModList IE, MobilityConfigToAddModList IE, or CellGroupConfigToAddModList IE), and each of the element(s) 2, . . . , N is an addition or modification IE (e.g., ConfigToAddMod IE, ReconfigToAddMod IE, CellConfigToAddMod IE, MobilityToAddMod IE, MobilityConfigToAddMod IE, or CellGroupConfigToAddMod IE). In further implementations, when the UE 102 receives the second addition or modification list, the UE 102 stores the second addition or modification list together with the first addition or modification list (e.g., in a variable in the RAM). In some implementations, the base station 104 includes cell ID(s) 2, . . . , N in the configuration(s) 2, . . . , N, respectively. The cell ID(s) 2, . . . , N identifies cell(s) 2, . . . , N, respectively. In some implementations, each of the cell ID(s) is a PCI. In some further implementations, the configuration(s) 2, . . . , N includes cell index(es) 2, . . . , N (e.g., serving cell index(es)), indexing the cell ID(s) 2, . . . , N or the cell(s) 2, . . . , N, respectively.

In some implementations, each of the configuration(s) 1 and/or 2, . . . , N is a CellGroupConfig IE. In such implementations, the following are example structures of the first or second addition or modification list (e.g., CellGroupConfigToAddModList IE), and CellGroupConfigToAddMod IE is an element of the first or second addition or modification list.

In some implementations, the base station 104 transmits, to the UE 102, a release list to release one or more configurations of the configuration(s) 1, . . . , N. For example, the base station 104 transmits an RRC reconfiguration message including the release list to the UE 102. In response, the UE 102 transmits an RRC reconfiguration complete message to the base station 104. In some implementations, the base station 104 includes ID(s) of the one or more configurations in the release list to indicate the one or more configurations to be released. The UE 102 identifies the one or more configurations in accordance with the ID(s) and releases the one or more configurations in response to the release list. In other implementations, the base station 104 transmits, to the UE 102, a third addition or modification list, which is empty or does not include a configuration, to release all of the configuration(s) 1, . . . , N. In some implementations, the base station 104 transmits an RRC reconfiguration message, including the third addition or modification list, to the UE 102. In response, the UE 102 transmits an RRC reconfiguration complete message to the base station 104. The UE 102 releases all of the configuration(s) 1, . . . , N in response to the third addition or modification list.

### Example Implementation 1

```
CellGroupConfigToAddModList : := SEQUENCE (SIZE
(1. . maxNrofConfigCells) ) OF
CellGroupConfigToAddMod
CellGroupConfigToAddMod : : = SEQUENCE {
  configId ConfigId,
cellGroupConfig OCTET STRING (CONTAINING
CellGroupConfig)
OPTIONAL,
  ...
}
CellGroupConfigToReleaseList : := SEQUENCE (SIZE
(1. . maxNrofConfigCells) )
OF ConfigId
maxNrofConfiqCells : : = 8
```

For example, the first addition or modification list is a first CellGroupConfigToAddModList IE, and the second addition or modification list is a second CellGroupConfigToAddModList IE. The element 1 is a CellGroupConfigToAddMod IE 1, and the element(s) 2, . . . , N is/are CellGroupConfigToAddMod IE(s) 2, . . . , N, respectively. The ID 1 and configuration 1 are a ConfigId and a CellGroupConfig IE in the CellGroupConfigToAddMod IE 1, respectively. The ID(s) 2, . . . , N and configuration(s) 2, . . . , N are a ConfigId and a CellGroupConfig IE in the CellGroupConfigToAddMod IE(s) 2, . . . , N, respectively. In some implementations, the first CellGroupConfigToAddModList IE includes the CellGroupConfigToAddMod IE 1, and the second CellGroupConfigToAddModList IE includes the CellGroupConfigToAddMod IE(s) 2, . . . , N. In further implementations, the first CellGroupConfigToAddModList IE includes the CellGroupConfigToAddMod IE(s) 1, . . . , N.

In some implementations, the release list is a CellGroupConfigToReleaseList IE. In further implementations, the base station 104 includes one or more ConfigID IEs in the CellGroupConfigToReleaseList IE to release one or more CellGroupConfigToAddMod IEs of the CellGroupConfigToAddMod IE(s) 1, . . . , N. The one or more CellGroupConfigToAddMod IEs are identified by the one or more ConfigID IEs.

### Example Implementation 2

Example Implementation 2 is similar to Example Implementation 1, except that the CellGroupConfigToAddMod IE does not include a ConfigId.

```
CellGroupConfigToAddModList : := SEQUENCE (SIZE
(0. . maxNrofConfigCells) ) OF
CellGroupConfigToAddMod
CellGroupConfigToAddMod : : = SEQUENCE {
  cellGroupConfig OCTET STRING (CONTAINING
CellGroupConfig)
OPTIONAL,
  . . .
}
maxNrofConfigCells : : = 8
```

In some implementations, the ID(s) 1, . . . , N are implicitly indicated by the order of the CellGroupConfigToAddMod IE(s) 1, . . . , N in the first or second CellGroupConfigToAddModList. For example, the CellGroupConfigToAddMod IE 1 is the first IE in the first CellGroupConfigToAddModList IE, which implicitly indicates that the ID 1 has value X. X can be zero or one. If the first CellGroupConfigToAddModList IE includes the CellGroupConfigToAddMod IE(s) 1, . . . , N in sequence, the ID(s) 1, . . . , N have values X, X+1, . . . , X+(N−1). In some implementations, if the base station 104 transmits the second CellGroupConfigToAddModList IE to the UE 102, the UE 102 and base station 104 replace the first CellGroupConfigToAddModList IE with the second CellGroupConfigToAddModList IE. If the second CellGroupConfigToAddModList IE includes the CellGroupConfigToAddMod IE(s) 2, . . . , N in sequence, the ID(s) 2, . . . , N are values X, X+1, . . . . X+N−2. If the second CellGroupConfigToAddModList IE includes the CellGroupConfigToAddMod IE(s) 1, . . . , N in sequence, the ID(s) 1, . . . , N are values X, X+1, . . . . X+N−1. In some alternative implementations, the ID(s) 1, . . . , N are the cell ID(s) 1, . . . , N.

In some implementations, the base station 104 transmits a CellGroupConfigToAddModList IE including zero CellGroupConfigToAddMod IE to release all of the CellGroupConfigToAddMod IE(s) 1, . . . , N.

In the Example Implementations 1 and 2, the “CellGroupConfigToAddModList”, “CellGroupConfigToAddMod”, “configId”, “ConfigId” “cellGroupConfig”, “CellGroupConfigToReleaseList”, and “maxNrofConfigCells” are exemplary only and should not be considered to restrict scope and application of the invention.

In other implementations, each of the configuration(s) 1 and/or 2, . . . , N is an RRCReconfiguration message. In such implementations, the following (i.e., Example Implementations 3-6) are example structures of the first or second addition or modification list.

### Example Implementation 3

In Example Implementation 3, the first or second addition or modification list is a CondReconfigToAddModList-r16 IE (e.g., as defined in 3GPP specification 38.331 from Release 16), and a CondReconfigToAddMod IE is an element of the list.

```
CondReconfigToAddModList-r16 : := SEQUENCE (SIZE
(1. . maxNrofCondCells-r16) )
OF CondReconfigToAddMod-r16
CondReconfigToAddMod-r16 : : = SEQUENCE {
    condReconfigId-r16 CondReconfigId-r16,
    condExecutionCond-r16 SEQUENCE (SIZE (1 .. 2) ) OF
MeasId
OPTIONAL, -- Need M
    condRRCReconfig-r16 OCTET STRING (CONTAINING
RRCReconfiguration) OPTIONAL, -- Cond
condReconfigAdd
    ... ,
    [ [
    condExecutionCondSCG-r17 OCTET STRING (CONTAINING
CondReconfigExecCondSCG-r17) OPTIONAL -- Need M
    ] ]
}
CondReconfigExecCondSCG-r17 : : = SEQUENCE (SIZE (1 .. 2) )
OF MeasId
CondReconfigToRemoveList-r16 : := SEQUENCE (SIZE
(1. . maxNrofCondCells-r16) )
OF CondReconfiaId-r16
```

For example, the first addition or modification list is a first CondReconfigToAddModList-r16 IE and a second CondReconfigToAddModList-r16 IE. The element 1 is a CondReconfigToAddMod-r16 IE 1, and the element(s) 2, . . . , N are CondReconfigToAddMod-r16 IE(s) 2, . . . , N, respectively. The ID 1 and configuration 1 are a CondReconfigId and an RRCReconfiguration message in the CondReconfigToAddMod IE 1, respectively. The ID(s) 2, . . . , N and configuration(s) 2, . . . , N are a CondReconfigId and an RRCReconfiguration message in the CondReconfigToAddMod IE(s) 2, . . . , N, respectively. In some implementations, the first CondReconfigToAddModList-r16 IE includes the CondReconfigToAddMod-r16 IE 1, and the second CondReconfigToAddModList-r16 IE includes the CondReconfigToAddMod-r16 IE(s) 2, . . . , N. In further implementations, the first CondReconfigToAddModList-r16 IE includes the CondReconfigToAddMod-r16 IE(s) 1, . . . , N.

In this example implementation, the base station 104 includes a condition configuration (i.e., condExecutionCond-r16) in at least one of the CondReconfigToAddMod-r16 IE(s). In some implementations, if the UE 102 supports a conditional procedure (e.g., conditional handover (CHO), conditional PSCell addition (CPA), or conditional PSCell change (CPC)), the UE 102 evaluates one or more conditions configured in the condExecutionCond-r16 field for the conditional procedure. If the UE 102 detects that at least one or all of the one or more conditions in the condExecutionCond-r16 field in a particular CondReconfigToAddMod-r16 IE is met, the UE 102 immediately applies configurations in an RRCReconfiguration message in the CondReconfigToAddMod-r16 IE (e.g., as described in 3GPP specification 38.331). In some implementations, the base station 104 does not include a condition configuration (i.e., condExecutionCond-r16) in any one or some of the CondReconfigToAddMod-r16 IE(s). Thus, the UE 102 is not configured to perform or does not perform any evaluation (i.e., detection or determination) of a condition for a conditional procedure (e.g., conditional handover) for the CondReconfigToAddMod-r16 IE(s) not including a condition configuration (i.e., condExecutionCond-r16).

In some implementations, the release list is a CondReconfigToRemoveList-r16 IE. In further implementations, the base station 104 includes one or more CondReconfigID IEs in the CondReconfigToRemoveList-r16 IE to release one or more CondReconfigToAddMod-r16 IEs of the CondReconfigToAddMod-r16 IE(s) 1, . . . , N. The one or more CondReconfigToAddMod-r16 IEs are identified by the one or more CondReconfigID IEs.

### Example Implementation 4

Example Implementation 4 is similar to Example Implementation 3, except that, in some implementations, a new indicator (e.g., fastServingCellChange-r18 field) is optionally included in a CondReconfigToAddMod-r16 IE. In some implementations, the new indicator indicates that the CondReconfigToAddMod-r16 IE (i.e., an RRCReconfiguration message or condRRCReconfig-r16 in the IE) is configured for fast serving cell change (i.e., see description for event 312). If the base station 104 does not include the new indicator in a CondReconfigToAddMod-r16 IE, the CondReconfigToAddMod-r16 IE is not configured for fast serving cell change.

```
CondReconfigToAddModList-r16 : : = SEQUENCE (SIZE
(1. . maxNrofCondCells-r16) )
OF CondReconfigToAddMod-r16
CondReconfigToAddMod-r16 : : = SEQUENCE {
    condReconfigId-r16 CondReconfigId-r16,
    condExecutionCond-r16 SEQUENCE (SIZE (1 .. 2) )
OF MeasId
OPTIONAL, -- Need M
    condRRCReconfig-r16 OCTET STRING (CONTAINING
RRCReconfiguration) OPTIONAL, -- Cond condReconfigAdd
    ... ,
    [ [
    condExecutionCondSCG-r17 OCTET STRING (CONTAINING
CondReconfigExecCondSCG-r17) OPTIONAL -- Need M
    ] ],
    [ [
    fastServingCellChange-r18 ENUMERATED { true}
OPTIONAL, - Cond EastServingCellChange M
    ] ]
}
CondReconfigExecCondSCG-r17 : : = SEQUENCE (SIZE (1 .. 2) )
OF MeasId
CondReconfigToRemoveList-r16 : := SEQUENCE (SIZE
(1. . maxNrofCondCells-r16) )
OF CondReconfiqId-r16
```

### Example Implementation 5

Some implementations of Example Implementations 3 and 4 may involve the UE 102 supporting conditional procedures (e.g., conditional handover (CHO), conditional PSCell addition (CPA), and/or conditional PSCell change (CPC)). If the UE 102 does not support the conditional procedures, the base station 104 does not configure or enable fast serving cell change for the UE 102. Thus, Example Implementation 5 decouples from the conditional procedures.

```
ReconfigToAddModList : := SEQUENCE (SIZE
(1. . maxNrofConfigCells) ) OF
ReconfigToAddMod
ReconfigToAddMod : : = SEQUENCE {
    configId ConfigId,
    cellGroupConfig OCTET STRING
(CONTAINING
RRCReconfiguration) OPTIONAL,
  ...
}
ReconfigToReleaseList : := SEQUENCE (SIZE
(1. . maxNrofConfigCells) ) OF
ConfigId
maxNrofConfigCells : : = 8
```

In some implementations, the first addition or modification list is a first ReconfigToAddModList IE and the second addition or modification list is a second ReconfigToAddModList IE. The element 1 is a ReconfigToAddMod IE 1, and the element(s) 2, . . . , N are ReconfigToAddMod IE(s) 2, . . . , N, respectively. The ID 1 and configuration 1 are a ConfigId and an RRCReconfiguration IE in the ReconfigToAddMod IE 1. The ID(s) 2, . . . , N and configuration(s) 2, . . . , N are a ConfigId and an RRCReconfiguration IE in the ReconfigToAddMod IE(s) 2, . . . , N, respectively. In some implementations, the first ReconfigToAddModList IE includes the ReconfigToAddMod IE 1 and the second ReconfigToAddModList IE includes the ReconfigToAddMod IE(s) 2, . . . , N. In further implementations, the first ReconfigToAddModList IE includes the ReconfigToAddMod IE 1, . . . , N.

In some implementations, the release list is a ReconfigToReleaseList IE. In further implementations, the base station 104 includes one or more ConfigID IEs in the ReconfigToReleaseList IE to release one or more ReconfigToAddMod IEs of the ReconfigToAddMod IE(s) 1, . . . , N. The one or more ReconfigToAddMod IEs are identified by the one or more ConfigID IEs.

### Example Implementation 6

```
ReconfigToAddModList : := SEQUENCE (SIZE
(0. . maxNrofConfigCells) ) OF
ReconfigToAddMod
ReconfigToAddMod : : = SEQUENCE {
    cellGroupConfig OCTET STRING
(CONTAINING
RRCReconfiguration) OPTIONAL,
  ...
}
maxNrofConfigCells : : = 8
```

Example Implementation 6 is similar to Example Implementation 5, except that the ReconfigToAddMod IE does not include a ConfigId. In some implementations, the ID(s) 1, . . . , N are implicitly indicated by the order of the ReconfigToAddMod IE(s) 1, . . . , N in the first or second ReconfigToAddModList. For example, the ReconfigToAddMod IE 1 is the first IE in the first ReconfigToAddModList IE, which implicitly indicates that the ID 1 has value X. X can be zero or one. If the first ReconfigToAddModList IE includes the ReconfigToAddMod IE(s) 1, . . . , N in sequence, the ID(s) 1, . . . , N have values X, X+1, . . . , X+(N−1). In some implementations, if the base station 104 transmits the second ReconfigToAddModList IE to the UE 102, the UE 102 and base station 104 replace the first ReconfigToAddModList IE with the second ReconfigToAddModList IE. If the second ReconfigToAddModList IE includes the ReconfigToAddMod IE(s) 2, . . . , N in sequence, the ID(s) 2, . . . , N are values X, X+1, . . . , X+N−2. If the second ReconfigToAddModList IE includes the ReconfigToAddMod IE(s) 1, . . . , N in sequence, the ID(s) 1, . . . , N have values X, X+1, . . . , X+N−1. In some alternative implementations, the ID(s) 1, . . . , N are the cell ID(s) 1, . . . , N.

In some implementations, the base station 104 transmits a ReconfigToAddModList IE including zero ReconfigToAddMod IE to release all of the ReconfigToAddMod IE(s) 1, . . . , N.

In the Example Implementations 5 and 6, the “ReconfigToAddModList”, “ReconfigToAddMod”, “configId”, “ConfigId”, “cellGroupConfig”, “ReconfigToReleaseList”, and “maxNrofConfigCells” are exemplary and should not restrict scope and application of the invention.

### Example Implementation 7

Example Implementation 7 is a combination of the Example Implementations 1 and 5, as shown below. Depending on implementation, any of the configuration(s) 1, . . . , N is a CellGroupConfig IE or an RRCReconfiguration message. Examples and implementations described for the Example Implementations 1 and 5 can apply to Example Implementation 7.

```
ReconfigToAddModList : : = SEQUENCE
(SIZE (1. . maxNrofConfigCells) ) OF
ReconfigToAddMod
ReconfigToAddMod : : = SEQUENCE {
    configId ConfigId,
    cellGroupConfig CHOICE {
        cellGroupConfig1 OCTET STRING
(CONTAINING CellGroupConfig)
OPTIONAL,
        cellGroupConfig2 OCTET STRING
(CONTAINING
RRCReconfiguration) OPTIONAL,
    }
    ...
}
ReconfigToReleaseList : := SEQUENCE (SIZE
(1. . maxNrofConfigCells) ) OF
ConfigId
maxNrofConfigCells : : = 8
```

After receiving the RRC reconfiguration message in the event 306 or transmitting the RRC reconfiguration complete message in the event 308, the UE 102 transmits 310 at least one measurement report to the base station 104, similar to the event 304. In some implementations, the at least one measurement report of the event 310 includes L1 measurement report(s), L3 measurement report(s), and/or new-type measurement report(s), as described for the event 304. In some implementations, the UE 102 transmits 310 the at least one measurement report on PUCCH(s) and/or PUSCH(s) to the base station 104, similar to the event 304. In other implementations, the UE 102 transmits 310 at least one MAC CE including the at least one measurement report to the base station 104, similar to the event 304. In some implementations, each of the at least one measurement report of the event 310 is not an RRC message.

In some implementations, the UE 102 transmits 310 the at least one measurement report to the base station 104 in accordance with at least one measurement configuration. The base station 104 transmits the at least one measurement configuration to the UE 102 to configure the UE 102 to perform measurements and report measurement results. For example, the base station 104 transmits one or more RRC messages (e.g., RRCReconfiguration message(s)), including the at least one measurement configuration, to the UE 102 after the event 304 or event 306. Depending on the implementation, the one or more RRC messages do or do not include the RRC reconfiguration message of the event 306. In accordance with the at least one measurement configuration, the UE 102 performs measurements on one or more reference signals. In some implementations, the one or more reference signals include one or more SSBs and/or one or more CSI-RSs. The UE 102 obtains the at least one L1 measurement result and/or at least one L3 measurement result from the measurements and includes the at least one L1 measurement result and/or at least one L3 measurement result in the at least measurement report of the event 310. The base station 104 transmits the one or more reference signals on the cells 124A and 124B, and, in further implementations, the cell 124C and/or other cell(s). In some implementations, the at least one measurement configuration includes L3 measurement configuration(s) (e.g., MeasConfig IE(s)), L1 measurement configuration(s) (e.g., CSI-MeasConfig IE(s)), and/or new-type measurement configuration(s), as described for the event 304.

In some implementations, the new-type measurement configuration(s) as described for the events 304 and 310 are similar to the L3 measurement configuration(s). For example, the new-type measurement configuration include a portion of configuration parameters defined in a MeasConfig IE. In other implementations, the new-type measurement configuration(s) as described for the events 304 and 310 are similar to the L1 measurement configuration(s). For example, the new-type measurement configuration include a portion of configuration parameters (e.g., CSI-ResourceConfig IE(s) and/or CSI-ReportConfig IE(s)) defined in a CSI-MeasConfig IE.

After (e.g., in response to) receiving the at least one measurement report in the event 310, the base station 104 transmits 312 a first configuration activation command to the UE 102 to activate the configuration 1. For example, the base station 104 transmits the first configuration activation command on the cell 124A. In another example, the base station 104 transmits the first configuration activation command on the cell 124D. In some implementations, the base station 104 includes the ID 1 in the first configuration activation command. The UE 102 determines and activates the configuration 1 in accordance with the first configuration activation command and ID 1. In other implementations, the base station 104 includes, in the first configuration activation command, the cell index 1 (e.g., a serving cell index) or cell ID 1 included in the configuration 1. The UE 102 determines and activates the configuration 1, in accordance with the first configuration activation command and the cell index 1 or cell ID 1.

In yet other implementations, the base station 104 includes a bit map in the first configuration activation command to activate the configuration 1, instead of the ID 1, cell ID 1, or cell index 1. The number of bits in the bit map is larger than or equal to “N”. In some implementations, bit 1, . . . , N corresponds to the configuration(s) 1, . . . , N, respectively, and the base station 104 sets a corresponding bit (e.g., bit 1) in the bit map to a first value to indicate the ID 1 or the configuration 1. In further implementations, bit 0, . . . , N−1 corresponds to the configuration(s) 1, . . . , N, respectively, and the base station 104 sets a corresponding bit (e.g., bit 0) in the bit map to a first value to indicate the ID 1 or the configuration 1. Thus, in some such implementations, the UE 102 determines the particular ID or particular configuration in accordance with the bit 1 or bit 0 set to the first value in the bit map. In such implementations, the base station 104 sets the remaining bits in the bit map to a second value to indicate that the reset of the configuration(s) 1, . . . , N is not activated. In some implementations, the first value is one and the second value is zero. In other implementations, the first value is zero and the second value is one. In some implementations, if the base station 104 determines to activate another configuration (e.g., configuration K) in addition to the configuration 1, the base station 104 sets the corresponding bit (e.g., bit K or bit K−1) in the bit map to the first value, where 1<=K<=N.

In some implementations, the at least one measurement report (e.g., L1 measurement report(s) and/or L3 measurement report(s)) of the event 310 includes at least one measurement result for the cell 124B. The base station 104 determines to activate the configuration 1 because the at least one measurement result indicates that signal strength or quality of the cell 124B is above a second predetermined threshold. The second predetermined threshold is different from the first predetermined threshold. In some implementations, the second predetermined threshold is larger than the first predetermined threshold. In such implementations, the at least one measurement report of the event 310 indicates that signal strength or quality of the cell 124B is suitable for communication with the UE 102. In further implementations, the second predetermined threshold is equal to the first predetermined threshold. In such implementations, the at least one measurement report of the event 310 indicates that signal strength or quality of the cell 124B has been continuously above the second predetermined threshold or the first predetermined threshold. This also indicates that the cell 124B is suitable for communication with the UE 102. Thus, the base station 104 determines to activate the configuration 1 (i.e., fast serving cell change to the cell 124B) in response to the signal strength or quality of the cell 124B being above the second predetermined threshold.

In some implementations, the first configuration activation command is a MAC CE included in a MAC PDU that the UE 102 receives from the base station 104 in the event 312. In some implementations, the MAC CE is a new MAC CE (e.g., as defined in 3GPP specification 38.321 v18.0.0 and/or later versions). In some implementations, the base station 104 includes a subheader identifying the MAC CE in the MAC PDU, and the UE 102 identifies the MAC CE in the MAC PDU in accordance with the subheader. In further implementations, the subheader includes a logical channel ID or extended logical channel ID (e.g., as defined in a 3GPP specification) to identify the MAC CE. For example, the logical channel ID or extended logical channel ID are newly defined (e.g., in 3GPP specification 38.321 v18.0.0 and/or later versions). In other implementations, the first configuration activation command is a DCI that the UE 102 receives on a PDCCH in the event 312. The base station 104 generates a CRC for the DCI, scrambles the CRC with a first C-RNTI of the UE 102, and transmits the DCI and scrambled CRC on the PDCCH in the event 312. In some implementations, a format of the DCI is an existing DCI format (e.g., as defined in a 3GPP specification (e.g., 38.212)). In further implementations, the format of the DCI is a new DCI format (e.g., as defined in a 3GPP specification (e.g., 38.212 v18.0.0 or later versions)).

In some implementations, the base station 104 does not perform security protection (e.g., integrity protection and/or encryption) on the first configuration activation command. This speeds up processing the first configuration activation command in the UE 102 because the UE 102 does not spend time performing the security check (e.g., decryption and/or integrity check) on the first configuration activation command.

In some implementations, after receiving the first configuration activation command, the UE 102 transmits 313 an acknowledgement to the base station 104 on the cell 124A or cell 124D to indicate that the UE 102 receives the first configuration activation command. In some implementations, the acknowledgement is a HARQ ACK. In other implementations, the acknowledgement is a MAC CE. For example, the MAC CE is an existing MAC CE (e.g., defined in 3GPP specification 38.321 v17.1.0). In another example, the MAC CE is a new MAC CE (e.g., defined in 3GPP specification 38.321 v18.0.0 and/or later versions). In yet other implementations, the acknowledgement is a PUCCH transmission.

In some implementations, the base station 104 transmits 306 the RRC reconfiguration message to the UE 102 in response to the L3 measurement report for the cell 124B that the base station 104 receives in the event 304. In some implementations, the base station 104 transmits an RRC reconfiguration message, including a MeasConfig IE, to the UE 102 to configure the UE 102 to transmit the L3 measurement report. In some implementations, the base station 104 transmits 312 the first configuration activation command in response to the L1 measurement report for the cell 124B that the base station 104 receives in the event 310. In further implementations, the base station 104 transmits a second RRC reconfiguration message, including a CSI-MeasConfig IE, to the UE 102 to configure the UE 102 to transmit the L1 measurement report. In some implementations, the first and second RRC reconfiguration messages are the same message (i.e., the same instance). In other implementations, the first and second RRC reconfiguration messages are different messages. In some implementations, the second RRC reconfiguration message is the RRC reconfiguration message of event 306. In other implementations, the second RRC reconfiguration message is different from the RRC reconfiguration message of event 306.

After (e.g., in response to) receiving the first configuration activation command, the UE 102 identifies the particular configuration (e.g., the configuration 1) in accordance with the particular ID (e.g., the ID 1) and immediately applies the configuration 1. In some implementations, the UE 102 performs 316 a random access procedure on the cell 124B with the base station 104 in response to applying the configuration 1. In some implementations, the UE 102 disconnects 314 from the cell 124A after (e.g., in response to) receiving 312 the first configuration activation command or transmitting 313 the acknowledgement. In other words, the UE 102 stops communicating on the cell 124A after (e.g., in response to) receiving 312 the first configuration activation command or transmitting 313 the acknowledgement. In such cases, the UE 102 performs 316 the random access procedure after disconnecting 314 from the cell 124A. In some implementations, the UE 102 determines whether to perform the random access procedure in accordance with the configuration 1. In some implementations, if the configuration 1 configures the UE 102 to perform a random access procedure, the UE 102 performs the random access procedure in the event 316. For example, the configuration 1 includes a reconfiguration with sync configuration (e.g., ReconfigurationWithSync IE) to configure the UE 102 to perform a random access procedure. Otherwise, if the configuration 1 does not configure the UE 102 to perform a random access procedure or configures the UE 102 to skip a random access procedure, the UE 102 refrains from performing a random access procedure with the base station 104 upon receiving the first configuration activation command. In such a cases, the UE 102 skips the event 316. For example, if the configuration 1 excludes a reconfiguration with sync configuration, the configuration 1 configures the UE 102 not to perform a random access procedure. In some implementations, the random access procedure is a four-step random access procedure. In other implementations, the random access procedure is a two-step random access procedure. In some implementations, the random access procedure is a contention-free random access procedure. In other implementations, the random access procedure is a contention-based random access procedure.

In cases where the UE 102 performs 316 the random access procedure, the UE 102 communicates 318 with the base station 104 on cell 124B in accordance with the configuration 1 after successfully completing the random access procedure. For example, the UE 102 communicates UL PDUs, DL PDUs, and/or physical layer signals (e.g., PUCCH transmissions and PDCCH transmissions) with the base station 104 in the event 318. In such cases, the UE 102 successfully completes the random access procedure when the UE 102 receives a contention resolution from the base station 104. In cases where the random access procedure is a four-step random access procedure, the UE 102 transmits a Message 3 including a UE identity to the base station 104 via the cell 124B in the random access procedure. In cases where the random access procedure is a two-step random access procedure, the UE 102 transmits a Message A including the UE identity to the base station 104 via the cell 124B in the random access procedure. In some implementations, if the configuration 1 includes a second C-RNTI, the UE identity is the second C-RNTI of the UE 102. Otherwise, if the configuration 1 does not include a C-RNTI, the UE identity is the first C-RNTI. In cases where the random access procedure is a contention free random access procedure, the UE 102 transmits the dedicated random access preamble to the base station 104 via the cell 124B. In such cases, the configuration 1 includes the dedicated random access preamble.

The base station 104 identifies or determines that the UE 102 connects to the cell 124B upon receiving the UE identity or the dedicated preamble from the UE 102 in the random access procedure.

In some implementations, the UE 102 transmits an RRC message (e.g., RRC reconfiguration complete message) to the base station 104 via the cell 124B to indicate that the UE 102 applies the configuration 1. In some implementations, the UE 102 includes the RRC message in the Message 3. In further implementations, the UE 102 includes the RRC message in the Message A. In yet further implementations, the UE 102 transmits the RRC message after completing the random access procedure. In other implementations, if the UE 102 maintains communication on the cell 124A with the base station 104 (i.e., the UE 102 does not disconnect from the cell 124A), the UE 102 transmits the RRC message to the base station 104 via the cell 124A. In yet other implementations, the UE 102 refrains from transmitting the RRC message to the base station 104 in response to applying the configuration 1 or receiving the first configuration activation command.

In some cases where the UE 102 skips the random access procedure, the UE 102 directly communicates 318 with the base station 104 on cell 124B in accordance with the configuration 1 after (e.g., in response to) receiving the first configuration activation command. For example, the UE 102 communicates UL PDUs, DL PDUs, and/or physical layer signals (e.g., PUCCH transmissions and PDCCH transmissions) with the base station 104 in the event 318. In some such cases, the UE 102 transmits at least one PUCCH transmission on the cell 124B to the base station 104 in accordance with the configuration 1 after (e.g., in response to) receiving the first configuration activation command. In some implementations, the base station 104 transmits at least one DCI on a PDCCH on the cell 124B to the UE 102 to command the UE 102 to transmit at least one PUCCH or PUSCH transmission after transmitting the first configuration activation command. The base station 104 identifies or determines that the UE 102 connects to the cell 124B upon receiving the PUCCH or PUSCH transmission. In other implementations, the UE 102 transmits the at least one PUCCH transmission regardless of receiving a DCI on a PDCCH on the cell 124B. The base station 104 identifies or determines that the UE 102 connects to the cell 124B upon receiving the PUCCH transmission. In some implementations, the UE 102 transmits an RRC message (e.g., RRC reconfiguration complete message) to the base station 104 via the cell 124B in the event 318 to indicate that the UE 102 applies the configuration 1. The base station 104 identifies or determines that the UE 102 connects to the cell 124B upon receiving the RRC message. In other implementations, if the UE 102 maintains communication on the cell 124A with the base station 104 (i.e., the UE 102 does not disconnect from the cell 124A), the UE 102 transmits the RRC message to the base station 104 via the cell 124A. In yet other implementations, the UE 102 refrains from transmitting the RRC message to the base station 104 in response to applying the configuration 1 or receiving the first configuration activation command.

In some implementations, when determining that the UE 102 connects to the cell 124B, transmitting 312 the first configuration activation command, or receiving 313 the acknowledgement, the base statin 104 stops communications with the UE 102 on the cell 124A. In some implementations, when determining that the UE 102 connects to the cell 124B, transmitting 312 the first configuration activation command, or receiving 313 the acknowledgement, the base statin 104 releases resources of the cell 124A configured for the UE 102.

The events 304, 306, 308, 310, 312, 314, 316 and 318 are collectively referred to in FIG. 3 as a fast serving cell configuration procedure 390.

In some implementations, the base station 104 generates the configuration 1 and/or configuration(s) 2, . . . , N as full configuration(s) replacing the first configuration or a particular configuration in the first configuration. If the configuration 1 is a full configuration, the UE 102 and base station 104 replace the first configuration or a particular configuration in the first configuration with the configuration 1. Thus, the UE 102 and base station 104 communicate 318 with each other in accordance with the configuration 1 instead of the first configuration or the particular configuration. In some implementations, the RRC reconfiguration message of the event 306 includes an indication that the configuration 1 is a full configuration. In other implementations, the configuration 1 includes an indication that the configuration 1 is a full configuration. In yet other implementations, the first container includes an indication that the configuration 1 is a full configuration. In yet other implementations, the element 1 (e.g., ConfigToAddMod IE, CellGroupConfigToAddMod, MobilityToAddMod IE, MobilityConfigToAddMod IE, or CellGroupConfigToAddMod IE) includes an indication that the configuration 1 is a full configuration. The UE 102 determines that configuration 1 is a full configuration based on the indication that the configuration 1 is a full configuration. In some implementations, the indication that the configuration 1 is different from a fullConfig field (e.g., as defined in the current 3GPP specifications). In other implementations, the indication that the configuration 1 is a fullConfig field in an RRCReconfiguration message (e.g., as defined in the current 3GPP specifications).

In other implementations, the base station 104 generates the configuration 1 and/or configuration(s) 2, . . . , N as delta configuration(s) augmenting at least a portion of the first configuration. In other words, the base station 104 generates the configuration(s) 1, . . . . N on top of the first configuration. For example, if the configuration 1 is a delta configuration, the UE 102 and base station 104 augment at least the portion of the first configuration with the configuration 1. Thus, the UE 102 and base station 104 communicate 318 with each other in accordance with the configuration 1 and unaugmented portion of the first configuration. In some implementations, the configuration 1 includes an indication that the configuration 1 is a delta configuration. In other implementations, the first container includes an indication that the configuration 1 is a delta configuration. In yet other implementations, the element 1 includes an indication that the configuration 1 is a delta configuration. The UE 102 can determine that configuration 1 is a full configuration based on the indication that the configuration 1 is a delta configuration. In some alternative implementations, the configuration 1, first container, or element 1 excludes an indication that the configuration 1 is a full configuration to indicate that the configuration 1 is a delta configuration. In further implementations, the UE 102 determines that the configuration 1 is a delta configuration based on a determination that the indication is excluded in the configuration 1, first container, or element 1.

In some implementations, if the configuration 1 is a full configuration, the UE 102 releases the first configuration or the particular configuration in the first configuration after (e.g., in response to) receiving 312 the first configuration activation command, transmitting 313 the acknowledgement, successfully performing the 316 the random access procedure, or receiving the first DCI on a PDCCH addressed to the UE identity of the UE 102 on the cell 124B. In some implementations, if the configuration 1 is a full configuration, the base station 104 releases the first configuration or the particular configuration in the first configuration after (e.g., in response to) transmitting 312 the first configuration activation command, receiving 313 the acknowledgement, successfully performing the 316 the random access procedure, or receiving a particular transmission from the UE 102 on the cell 124B. In some implementations, the particular transmission is a PUCCH transmission. In further implementations, the transmission is a PUSCH transmission. In further implementations, after transmitting the first configuration activation command, the base station 104 generates a DCI and a CRC of the DCI, scrambles the CRC with the UE identity of the UE 102, and transmits the DCI and scrambled CRC on a PDCCH on the cell 124B. When the UE 102 receives the DCI and scrambled CRC and verifies the scrambled CRC is valid using the UE identity, the UE 102 transmits the PUSCH transmission to the base station 104 on the cell 124B.

In some implementations, the first configuration or the particular configuration is a first CellGroupConfig IE (i.e., the first configuration includes configuration parameters defined in the first CellGroupConfig IE), and the configuration 1 is a second CellGroupConfig IE.

In some implementations, the UE 102 uses a UE MAC entity (e.g., MAC 204B) to communicate with the base station 104 (e.g., the events 302, 304, 306, 308, 310, and/or 312). In some implementations, the base station 104 configures whether the UE 102 resets the UE MAC entity upon receiving 312 the first configuration activation command. In some implementations, the base station 104 includes a MAC reset indication in the configuration 1 or element 1 to configure the UE 102 to reset the UE MAC entity, and excludes the MAC reset indication in the configuration 1 or element 1 to configure the UE 102 not to reset the UE MAC entity. If the configuration 1 or element 1 includes the MAC reset indication, the UE 102 resets the UE MAC entity in response to the MAC reset indication, upon receiving 312 the first configuration activation command.

Otherwise, if the configuration 1 or element 1 does not include the MAC reset indication, the UE 102 refrains from resetting the UE MAC entity upon or when receiving the first configuration activation command. In some implementations, if the configuration 1 or element 1 does not include the MAC reset indication and includes an indication that the configuration is a full configuration, the UE 102 resets the UE MAC entity upon or when receiving the first configuration activation command. Otherwise, if the configuration 1 or element 1 does not include the MAC reset indication and the indication that the configuration is a full configuration, the UE 102 refrains from resetting the UE MAC entity upon or when receiving the first configuration activation command.

In some implementations, the base station 104 uses a base station MAC entity (e.g., NR MAC 204B) to communicate with the UE 102 (e.g., the events 302, 304, 306, 308, 310, and/or 312). If the base station 104 includes the MAC reset indication in the configuration 1 or element 1, the base station 104 resets the base station MAC entity in response to the MAC reset indication, after transmitting the first configuration activation command in the event 312, receiving the acknowledgement in the event 313, or determining that the UE 102 connects to the cell 124B in the event 316 or 318.

Otherwise, if the configuration 1 or element 1 does not include the MAC reset indication, the base station 104 refrains from resetting the base station MAC entity after (e.g., in response to) transmitting 312 the first configuration activation command. Thus, the base station 104 continues to use the retained (i.e., un-reset) base station MAC entity to communicate with the UE 102 after transmitting the first configuration activation command in the event 312, receiving the acknowledgement in the event 313, or determining that the UE 102 connects to the cell 124B in the event 316 or 318. In cases where the base station 104 is a disaggregated base station, the base station 104 can determine whether to include the MAC reset indication in the configuration 1 or element 1 depending on whether the cells 124A and 124B belong to the same DU or not. If the cells 124A and 124B belong to the same DU, the base station 104 determines not to include or does not include the MAC reset indication in the configuration 1 or element 1. Otherwise, if the cells 124A and 124B belong to different DUs, the base station 104 determines to include or includes the MAC reset indication in the configuration 1 or element 1.

In some implementations, the base station 104 includes the MAC reset indication in a MAC-CellGroupConfig IE in the configuration 1 (e.g., CellGroupConfig IE). In other implementations, the base station 104 includes the MAC reset indication in the CellGroupConfig IE and outside the MAC-CellGroupConfig IE. In yet other implementations, the base station 104 includes the MAC reset indication in the element 1 and outside the configuration 1.

In some implementations, if the configuration 1 or element 1 does not include the MAC reset indication and includes an indication that the configuration 1 is a full configuration, the base station 104 resets the base station MAC entity after transmitting the first configuration activation command in the event 312, receiving the acknowledgement in the event 313, or determining that the UE 102 connects to the cell 124B in the event 316 or 318. Alternatively, the base station 104 releases the base station MAC entity and establishes a new base station MAC entity for communication with the UE 102 via the cell 124B instead of resetting the base station MAC entity. Otherwise, if the configuration 1 or element 1 does not include the MAC reset indication and the indication that the configuration 1 is a full configuration, the base station 104 refrains from resetting the base station MAC entity after (e.g., in response to) transmitting the first configuration activation command in the event 312.

In some alternative implementations, the base station 104 includes a MAC retention indication in the configuration or element (e.g., the configuration 1 or element 1) to configure the UE 102 to not reset the UE MAC entity, and excludes the MAC retention indication in the configuration or element to configure the UE 102 to reset the UE MAC entity. If the configuration or element includes the MAC retention indication, the UE 102 refrains from resetting the UE MAC entity in response to the MAC retention indication, upon receiving a configuration activation command (e.g., the first configuration activation command). Otherwise, if the configuration or element does not include the MAC retention indication, the UE 102 resets the UE MAC entity upon or when receiving the configuration activation command.

The base station 104 uses a base station MAC entity (e.g., NR MAC 204B) to communicate with the UE 102 (e.g., the events 302, 304, 306, 308, 310, and/or 312). If the base station 104 includes the MAC retention indication in the configuration or element (e.g., the configuration 1 or element 1), the base station 104 refrains from resetting a base station MAC entity in response to the MAC retention indication after transmitting the configuration activation command (e.g., the first configuration activation command) to the UE 102. Thus, the base station 104 continues to use the retained (i.e., un-reset) base station MAC entity to communicate with the UE 102 after transmitting 312 the first configuration activation command, receiving 313 the acknowledgement, or determining that the UE 102 connects to the cell 124B in the event 316 or 318.

In some implementations, the base station 104 includes the MAC retention indication in a MAC-CellGroupConfig IE in the configuration 1 (e.g., CellGroupConfig IE). In other implementations, the base station 104 includes the MAC retention indication in the CellGroupConfig IE and outside the MAC-CellGroupConfig IE. In yet other implementations, the base station 104 includes the MAC retention indication in the element 1 and outside the configuration 1.

Otherwise, if the configuration 1 or element 1 does not include the MAC retention indication, the base station 104 resets the base station MAC entity after (e.g., in response to) transmitting 312 the first configuration activation command. In some cases where the base station 104 is a disaggregated base station, the base station 104 determines whether to include the MAC reset indication in the configuration 1 or element 1 depending on whether the cells 124A and 124B belong to the same DU or not. If the cells 124A and 124B belong to the same DU, the base station 104 determines includes the MAC retention indication in the configuration 1 or element 1. Otherwise, if the cells 124A and 124B belong to different DUs, the base station 104 determines to not include the MAC retention indication in the configuration 1 or element 1.

In some implementations, base station 104 may or may not include an indication that the configuration 1 is a full configuration. If the base station 104 includes, in the configuration 1 or element 1, the indication that the configuration 1 is a full configuration, the base station 104 refrains from including the MAC retention indication in the configuration 1 or element 1. Otherwise, in further implementations, if the base station 104 does not include, in the configuration 1 or element 1, the indication that the configuration 1 is a full configuration, the base station 104 includes the MAC retention indication in the configuration 1 or element 1.

In further alternative implementation, the base station 104 includes a MAC partial reset indication in a configuration or element (e.g., the configuration 1 or element 1) to configure the UE 102 to partially reset the UE MAC entity, and excludes the MAC partial reset indication in the configuration or element to configure that the UE 102 fully resets the UE MAC entity. If the configuration or element includes the MAC partial reset indication, the UE 102 partially resets the UE MAC entity upon receiving a configuration activation command (e.g., the first configuration activation command). Otherwise, if the configuration or element does not include the MAC partial reset indication, the UE 102 fully resets the UE MAC entity after (e.g., in response to) receiving the configuration activation command. In some implementations, when the UE partially resets the UE MAC entity, the UE 102 retains (e.g., maintains or keeps) an operation state of the UE MAC entity or omits one or more actions that the UE 102 may perform when the UE 102 fully resets the UE MAC entity.

If the base station 104 includes the MAC partial reset indication in the configuration or element (e.g., the configuration 1 or element 1), the base station 104 partially resets the base station MAC entity in response to the MAC partial reset indication after transmitting the configuration activation command (e.g., the first configuration activation command) to the UE 102.

In some implementations, the base station 104 includes the MAC partial reset indication in a MAC-CellGroupConfig IE in the configuration 1 (e.g., CellGroupConfig IE). In other implementations, the base station 104 includes the MAC partial reset indication in the CellGroupConfig IE and outside the MAC-CellGroupConfig IE. In yet other implementations, the base station 104 includes the MAC partial reset indication in the element 1 and outside the configuration 1.

Otherwise, if the configuration 1 or element 1 does not include the MAC partial reset indication, the base station 104 fully resets the base station MAC entity after (e.g., in response to) transmitting 312 the first configuration activation command.

In some implementations, base station 104 does or does not include an indication that the configuration 1 is a full configuration. In some implementations, if the base station 104 includes, in the configuration 1 or element 1, the indication that the configuration 1 is a full configuration, the base station 104 refrains from including the MAC partial reset indication in the configuration 1 or element 1. Otherwise, in further implementations, if the base station 104 does not include, in the configuration 1 or element 1, the indication that the configuration 1 is a full configuration, the base station 104 includes the MAC partial reset indication in the configuration 1 or element 1. In some alternative implementations, the base station 104 includes the MAC partial reset indication in cases where the base station 104 includes, in the configuration 1 or element 1, the indication that the configuration 1 is a full configuration.

In some implementations, the base station 104 does not include, in a configuration or element (e.g., the configuration 1 or element 1) or an RRC message (e.g., events 306) including the configuration or element, an indication related to resetting the UE MAC entity. In such cases, the UE 102 partially resets the UE MAC entity after (e.g., in response to) receiving the first configuration activation command. In such cases, the base station 104 partially resets the base station MAC entity after transmitting the first configuration activation command, receiving 331 the acknowledgement, performing 336 the random access procedure with the UE 102, or determining that the UE 102 connects to the cell 124B.

In some implementations, when the UE 102 determines to reset or resets the UE MAC entity as described above, the UE 102 resets the UE MAC entity before performing 316 the random access procedure or communicating 318 with the base station 104 via the cell 124B. In some implementations, when the UE 102 resets the UE MAC entity, the UE 102 performs at least one of the following actions for the UE MAC entity (i.e., UE MAC reset or full UE MAC reset): (i) initialize Bj for configured logical channel(s) to zero; (ii) stop one or more timers; (iii) consider timeAlignmentTimer(s) as expired, if the UE 102 is configured to perform the random access procedure (e.g., the event 316) in the configuration (e.g., the configuration 1); (iv) set new data indicator(s) (NDI(s)) for UL HARQ process(es) to value 0; (v) set NDI(s) for HARQ process ID(s) to value 0 for monitoring PDCCH in Sidelink resource allocation mode 1; (vi) flush Msg3 buffer; (vii) flush MSGA buffer; (viii) cancel, if any, triggered Scheduling Request procedure; (ix) cancel, if any, triggered Buffer Status Reporting procedure; (x) cancel, if any, triggered Power Headroom Reporting procedure; (xi) cancel, if any, triggered consistent LBT failure; (xii) cancel, if any, triggered BFR; (xiii) cancel, if any, triggered Sidelink Buffer Status Reporting procedure; (xiv) cancel, if any, triggered Pre-emptive Buffer Status Reporting procedure; (xv) cancel, if any, triggered Timing Advance Reporting procedure; (xvi) cancel, if any, triggered Recommended bit rate query procedure; (xvii) cancel, if any, triggered configured uplink grant confirmation; (xviii) cancel, if any, triggered configured sidelink grant confirmation; (xix) cancel, if any, triggered Desired Guard Symbol query; (xx) cancel, if any, triggered Positioning Measurement Gap Activation/Deactivation Request procedure; (xxi) flush soft buffers for DL HARQ process(es); (xxii) for each of the DL HARQ process(es), consider the next received transmission for a TB as the very first transmission; (xxiii) release, if any, Temporary C-RNTI; (xiv) reset one or more counters (e.g., BFI_COUNTERs and/or LBT_COUNTERs); (xxv) etc.

In some implementations, when the base station 104 resets the base station MAC entity, the base station 104 performs at least one of the following actions for the base station MAC entity (i.e., base station MAC reset or full base station MAC reset): (i) stop one or more timers; (ii) consider timeAlignmentTimer(s) that the base station 104 starts and/or maintains for the UE 102 as expired, if the UE 102 is configured to perform the random access procedure (e.g., the event 332) in the configuration (e.g., the configuration 1); (iii) set NDI(s) for DL HARQ process(es) to value 0; (iv) flush soft buffers for UL HARQ process(es); (v) for each of the UL HARQ process(es), consider the next received transmission for a TB as the very first transmission; (vi) reset one or more counters (e.g., BFI_COUNTERs and/or LBT_COUNTERs); (vii) etc.

Depending on implementations, the UE 102 determines to partially or fully reset the UE MAC entity. In some implementations, when the UE 102 resets the UE MAC entity as described above, the UE 102 fully resets the UE MAC entity (i.e., a full UE MAC reset). In the full UE MAC reset, the UE 102 performs some or all of the actions described above. In other implementations, when the UE 102 resets the UE MAC entity as described above, the UE 102 partially resets the UE MAC entity (i.e., a partial UE MAC reset). In the partial UE MAC reset, the UE 102 performs a subset or portion of the some or all of the actions in the full UE MAC reset.

In some implementations, the partial UE MAC reset includes at least one of the following actions: (i) consider timeAlignmentTimer(s) of the UE 102 as expired, if the UE 102 is configured to perform the random access procedure (e.g., the event 332) in the configuration (e.g., the configuration 1); (ii) flush Msg3 buffer; (iii) flush MSGA buffer; (iv) release, if any, Temporary C-RNTI; and/or (v) reset one or more counters (e.g., BFI_COUNTERs and/or LBT_COUNTERs).

In some implementations, the partial UE MAC reset further includes at least one of the following actions: (i) cancel, if any, triggered Scheduling Request procedure; (ii) cancel, if any, triggered Buffer Status Reporting procedure; (iii) cancel, if any, triggered Power Headroom Reporting procedure; (iv) cancel, if any, triggered consistent LBT failure; (v) cancel, if any, triggered BFR; (vi) cancel, if any, triggered Sidelink Buffer Status Reporting procedure; (vii) cancel, if any, triggered Pre-emptive Buffer Status Reporting procedure; (viii) cancel, if any, triggered Timing Advance Reporting procedure; (ix) cancel, if any, triggered Recommended bit rate query procedure; (x) cancel, if any, triggered configured uplink grant confirmation; (xi) cancel, if any, triggered configured sidelink grant confirmation; (xii) cancel, if any, triggered Desired Guard Symbol query; and/or (xiii) cancel, if any, triggered Positioning Measurement Gap Activation/Deactivation Request procedure.

In some implementations, the partial UE MAC reset further includes at least one of the following actions: (i) stop a first portion of the one or more timers and retain the rest of the one or more timers; (ii) set new data indicator(s) (NDI(s)) for UL HARQ process(es) to value 0; (iii) set NDI(s) for HARQ process ID(s) to value 0 for monitoring PDCCH in Sidelink resource allocation mode 1; (iv) flush soft buffers for DL HARQ process(es); and/or (v) for each of the DL HARQ process(es), consider the next received transmission for a TB as the very first transmission.

Depending on the implementation, the base station 104 determines to partially or fully reset the base station MAC entity. In some implementations, when the base station 104 resets the base station MAC entity as described above, the base station 104 fully resets the base station MAC entity (i.e., a full base station MAC reset). In the full base station MAC reset, the base station 104 performs some or all of the actions described above. In other implementations, when the base station 104 resets the base station MAC entity as described above, the base station 104 partially resets the base station MAC entity (i.e., a partial base station MAC reset). In the partial base station MAC reset, the base station 104 performs a subset or portion of the some or all of the actions in the full base station MAC reset.

In some implementations, the partial base station MAC reset includes at least one of the following actions in the partial MAC reset: (i) consider timeAlignmentTimer(s), that the base station 104 starts and/or maintains for the UE 102, as expired, if the UE 102 is configured to perform the random access procedure (e.g., the event 332) in the configuration (e.g., the configuration 1); and/or (ii) reset one or more counters (e.g., BFI_COUNTERs and/or LBT_COUNTERs).

In some implementations, when the partial base station MAC reset includes at least one of the following actions for the MAC entity (i.e., base station MAC reset): (i) stop a first portion of the one or more timers and retain the rest of the one or more timers; (ii) set NDI(s) for DL HARQ process(es) to value 0; (iii) flush soft buffers for UL HARQ process(es); (iv) for each of the UL HARQ process(es), consider the next received transmission for a TB as the very first transmission; and/or (v) reset one or more counters (e.g., BFI_COUNTERS and/or LBT_COUNTERs).

In some implementations, the configuration 1 does or does not include one or more RLC reestablishment indications (e.g., reestablishRLC field(s)) configuring the UE 102 to reestablish one or more RLC entities (e.g., RLC 206B) that the UE 102 uses to communicate with the base station 104 (e.g., the events 302, 304, 306, 308, 310 and/or 312). If the configuration 1 includes the RLC reestablishment indication configuring the UE 102 to reestablish a RLC entity (e.g., RLC 206B) that the UE 102 uses to communicate RLC PDU(s) with the base station 104 (e.g., the events 302, 304, 306, 308, 310 and/or 312), the UE 102 reestablishes the RLC entity in response to the RLC reestablishment indication. In some implementations, the UE 102 reestablishes the RLC entity before performing 316 the random access procedure or communicating 318 with the base station 104 via the cell 124B. In other implementations, the UE 102 reestablishes the RLC entity while or after performing 316 the random access procedure. In some implementations, when the UE 102 reestablishes the RLC entity, the UE 102 performs at least one of the following actions for the RLC entity: (i) discard RLC SDU(s), RLC SDU segment(s), and RLC PDU(s), if any; (ii) stop and reset timer(s), if running; (iii) reset state variables to initial values; (iv) etc. In some implementations, the state variables and timer(s) are currently defined (e.g., in 3GPP specification 38.322).

Otherwise, if the configuration 1 does not include the RLC reestablishment indication for the RLC entity, the UE 102 refrains from reestablishing the RLC entity upon or when receiving the first configuration activation command. In other words, the UE 102 refrains from performing the actions for reestablishing the RLC entity of the UE 102 upon or when receiving the first configuration activation command. In some implementations, if the configuration 1 or element 1 does not include the RLC reestablishment indication and includes an indication that the configuration 1 is a full configuration, the UE 102 reestablishes the RLC entity of the UE 102 upon or when receiving the first configuration activation command. Otherwise, if the configuration 1 or element 1 does not include the RLC reestablishment indication and the indication that the configuration 1 is a full configuration, the UE 102 refrains from reestablishing the RLC entity upon or when receiving the first configuration activation command.

Similarly, the base station 104 reestablishes a RLC entity (e.g., NR RLC 206B) that the base station 104 uses to communicate with the RLC entity of the UE 102 (e.g., the events 302, 304, 306, 308, 310 and/or 312) in response to the RLC reestablishment indication. In some implementations, the base station 104 reestablishes the RLC entity after transmitting the first configuration activation command, receiving an acknowledgement for the first configuration activation command from the UE 102, or determining that the UE 102 connects to the cell 124B. In some implementations, the acknowledgement is a HARQ ACK. In other implementations, the acknowledgement is a MAC CE. In yet other implementations, the acknowledgement is a PUCCH transmission. In some implementations, when the base station 104 reestablishes the RLC entity, the base station 104 performs at least one of the following actions for the RLC entity: (i) discard RLC SDU(s), RLC SDU segment(s), and RLC PDU(s), if any; (ii) stop and reset timer(s), if running; (iii) reset state variables to initial values; (iv) etc. In some implementations, the state variables and timer(s) are currently defined (e.g., in 3GPP specification 38.322).

In some implementations, the above description for the configuration 1 applies to the configuration(s) 2, . . . , N as well.

Referring next to FIG. 4A, in a scenario 400A, the base station 106 operates as an MN, and the base station 104 operates as an SN. Initially, the UE 102 in DC communicates with the MN 106 and with SN 104. In the event 402, the UE 102 communicates with the SN 104 on the cell 124A in accordance with a first configuration, similar to the event 302. In some implementations, the UE 102 in DC communicates 402 UL PDUs and/or DL PDUs with the MN 106 and/or SN 104 via radio bearers which can include SRBs and/or DRB(s). In further implementations, the MN 106 and/or the SN 104 configure the radio bearers for the UE 102. The UE 102 in DC communicates 402 UL PDUs and/or DL PDUs with the SN 104 on an SCG that the SN 104 configures for communication with the UE 102. The UE 102 in DC communicates UL PDUs and/or DL PDUs with the MN 106 on an MCG in accordance with an MN configuration (i.e., MCG configuration). In some implementations, the first configuration is an SN configuration (i.e., SCG configuration). In the MN configuration, the MN 106 configures the MCG which includes at least one serving cell (e.g., the cell 126 and/or other cell(s)) operated by the MN 106. In the first configuration, the SN 106A configures the SCG which includes at least one serving cell (e.g., the cell 124A and/or other cell(s)) operated by the SN 104. In some implementations, the MN configuration includes multiple configuration parameters, and the UE 102 receives the configuration parameters in one or more RRC messages from the MN 106. In other implementations, the first configuration includes multiple configuration parameters, and the UE 102 receives the configuration parameters in one or more RRC messages from the SN 104 (e.g., via the MN 106) or on an SRB (e.g., SRB3) that the MN 106 or SN 104 configures to exchange RRC messages between the UE 102 and the SN 104.

In some implementations, while the UE 102 communicates in DC with the MN 106 and SN 104, the MN 106 performs 490 a fast serving cell change procedure with the UE 102. In further implementations, while communicating in DC with the MN 106 and SN 104, the UE 102 transmits 401 at least one measurement report to the MN 106 via the cell 126, similar to the event 304. The MN 106 in turn transmits 403 the at least one measurement report to the SN 104. In some implementations, the MN 106 generates at least one interface message including the at least one measurement report and transmits the at least one interface message to the SN 104 in the event 403. In some implementations, the at least one interface message includes RRC Transfer message(s) and/or SN Modification Request message(s). Alternatively, the UE 102 transmits 404 the at least one measurement report to the SN 104 via the cell 124A, similar to the event 304.

After (e.g., in response to) receiving the at least one measurement report or while the base station 104 communicates with the UE 102, the base station 104 determines to prepare the cell 124B as described for FIG. 3. The events 406, 408, 410, 412, 413, 414, 416, and 418 are similar to the events 306, 308, 310, 312, 313, 314, 316, and 318, respectively. After receiving the first configuration activation command, transmitting the acknowledgement, or determining that the UE 102 connects to the cell 124B, the UE 102 operating in DC with the MN 106 and SN 104 communicates 418 with the SN 104 on the cell 124B in accordance with the configuration 1, similar to the event 318.

Referring next to FIG. 4B, a scenario 400B is generally similar to the scenario 400A, except that the SN 104 transmits 405, 407 the RRC reconfiguration message to the UE 102 via the MN 106 and receives 409, 411 the RRC reconfiguration complete message from the UE 102 via the MN 106. In some implementations, the SN 104 generates a first interface message (e.g., SN Modification Required message, SN Modification Required message, or RRC Transfer message) including the RRC reconfiguration message and transmits the first interface message to the MN 106 in the event 405. In some implementations, the MN 106 generates a second interface message (e.g., SN Reconfiguration Complete message or RRC Transfer message), including the RRC reconfiguration complete message, and transmits the second interface message to the SN 104 in the event 411.

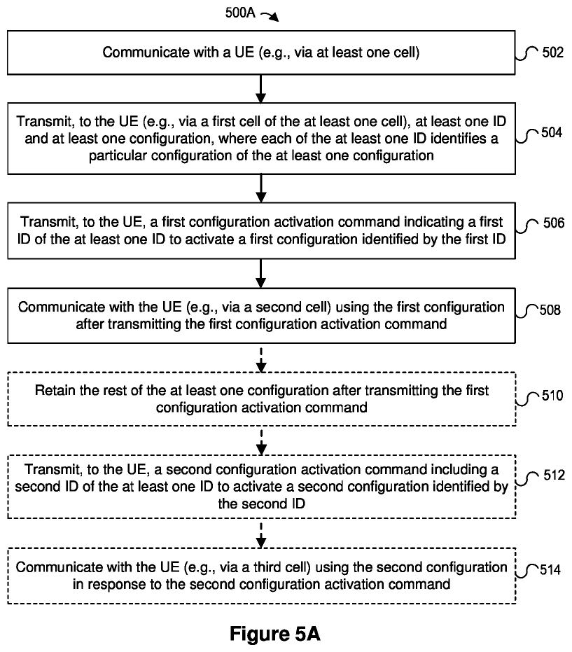

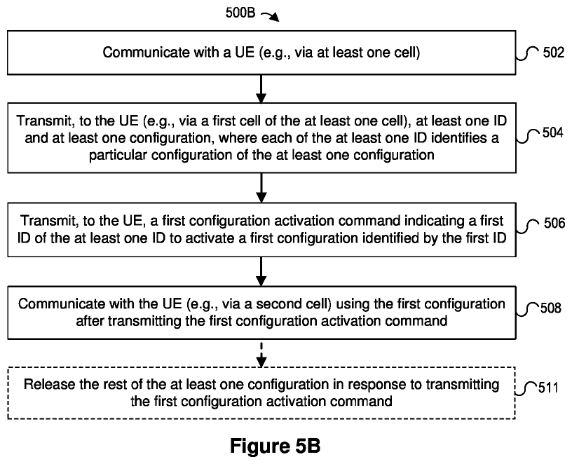

Next, several example methods, implemented in one or more RAN nodes, such as base stations, DUs, or CUs, or in a RAN to support configuring a configuration and activating the configuration later are discussed with reference to FIGS. 5A-10. Examples and implementations described for FIGS. 3-4B can apply to FIGS. 5A-10.

FIG. 5A illustrates a method 500A, which can be implemented by a RAN node (e.g., the base station 104 or 106, DU 174, or CU 172), for configuring and activating a serving cell configuration for a UE (e.g., the UE 102).

The method 500A begins at block 502, where the RAN node communicates with a UE (e.g., via at least one cell) (e.g., events 302, 390, 402, 490). At block 504, the RAN node transmits, to the UE (e.g., via a first cell of the at least one cell), at least one ID and at least one configuration, where each of the at least one ID identifies a particular configuration of the at least one configuration (e.g., events 306, 390, 406, 405, 407, 490). At block 506, the RAN node transmits, to the UE, a first configuration activation command indicating a first ID of the at least one ID to activate a first configuration identified by the first ID (e.g., events 310, 410,390, 490). At block 508, the RAN node communicates with the UE (e.g., via a second cell) using the first configuration after transmitting the firs configuration activation command (e.g., events 316, 318, 390, 416, 418, 490). In some implementations, at block 510, the RAN node retains the rest of the at least one configuration after transmitting the first configuration activation command. In further implementations, at block 512, the RAN node transmits, to the UE, a second configuration activation command including a second ID of the at least one ID to activate a second configuration identified by the second ID (e.g., events 306, 390, 406, 405, 407, 490). In still further implementations, at block 514, the RAN node communicates with the UE (e.g., via a third cell) using the second configuration in response to the second configuration activation command (e.g., events 316, 318, 390, 416, 418, 490).

FIG. 5B is a flow diagram of an example method 500B similar to the method 500A, except that method 500B includes block 511 instead of blocks 510, 512, and 514. At block 511, the RAN node releases the rest of the at least one configuration in response to transmitting the first configuration activation command. In some implementations, the RAN node transmits an RRC message, including the second configuration and third configuration, to the UE (e.g., events 316, 318, 416, 418). In other implementations, the RAN node transmits a first RRC message including the second configuration to the UE (e.g., events 316, 318, 416, 418) and transmits a second RRC message including the third configuration to the UE. In some implementations, the first and second RRC messages are RRC reconfiguration messages. In some implementations, one of the second configuration and third configuration is the configuration 1 and the other is one of the configuration(s) 2, . . . , N described for FIG. 3.

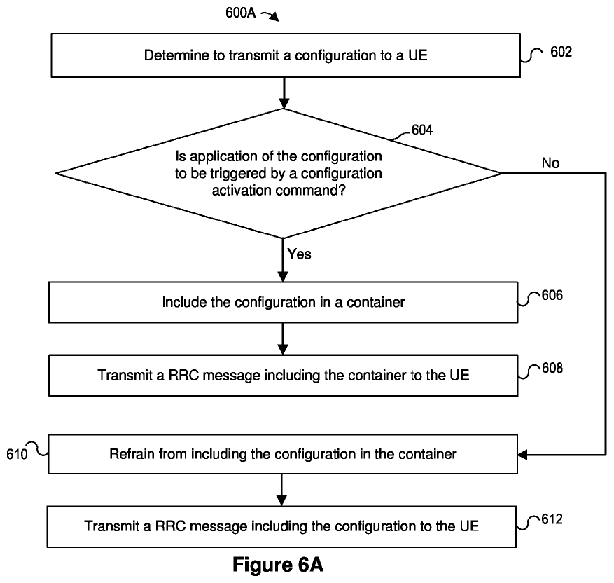

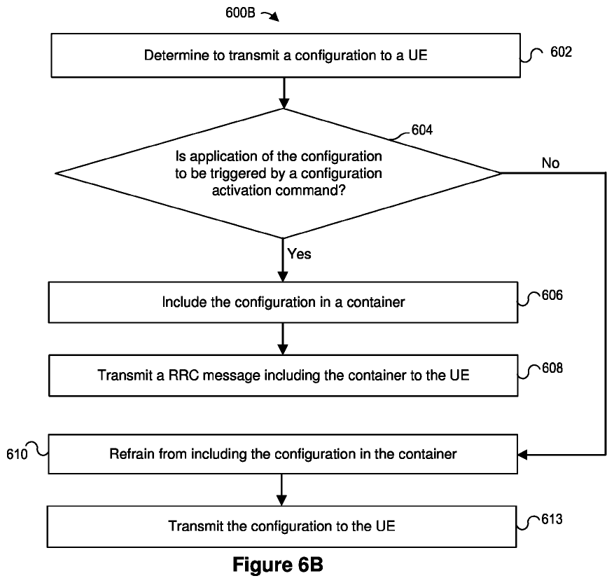

FIG. 6A illustrates a method 600A, which can be implemented by a RAN node (e.g., the base station 104 or 106, DU 174, or CU 172), for transmitting a serving cell configuration to a UE (e.g., the UE 102).

The method 600A begins at block 602, where the RAN node determines to transmit a configuration to a UE. At block 604, the RAN node determines whether application of the configuration is to be triggered by a configuration activation command. If application of the configuration is to be triggered by a configuration activation command, the flow proceeds to block 606. At block 606, the RAN node includes the configuration in a container. At block 608, the RAN node transmits an RRC message including the container to the UE (e.g., events 306, 390, 406, 405, 407, 490). Otherwise, if application of the configuration is not to be triggered by a configuration activation command, the flow proceeds to block 610. At block 610, the RAN node refrains from including the configuration in the container. At block 612, the RAN node transmits an RRC message including the configuration to the UE. In some implementations, the RRC message is an RRC reconfiguration message. In some implementations, the configuration at block 612 is a cell group configuration (e.g., CellGroupConfig IE).

FIG. 6B is a flow diagram of an example method 600B similar to the method 600A, except that method 600B includes block 613 instead of block 612. At block 613, the RAN node transmits the configuration to the UE. In some implementations, the configuration is an RRC reconfiguration message. In such cases, the RAN node transmits the configuration to the UE without using an RRC message to transmit the configuration. In further implementations, the RAN node generates a PDCP PDU, including the configuration, and transmits the PDCP PDU to the UE.

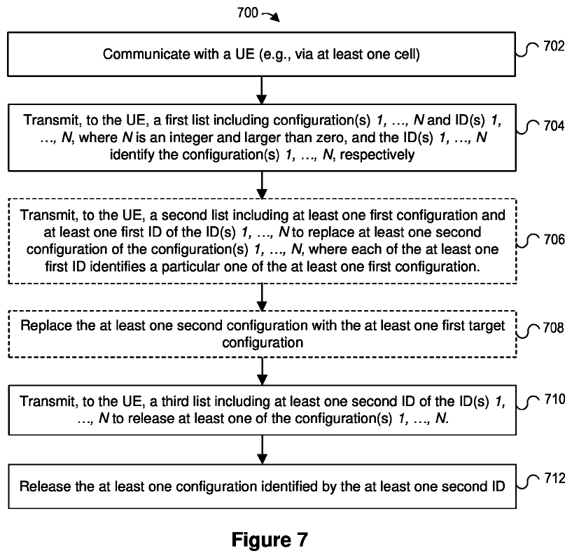

FIG. 7 illustrates a method 700A, which can be implemented by a RAN node (e.g., the base station 104 or 106, DU 174, or CU 172), for adding, modifying, and/or releasing a serving cell configuration for a UE (e.g., the UE 102).

The method 700 begins at block 702, where the RAN node communicates with a UE (e.g., via at least one cell) (e.g., events 302, 390, 402, 490). At block 704, the RAN node transmits, to the UE, a first list including configuration(s) 1, . . . , N and ID(s) 1, . . . , N, where N is an integer and larger than zero, and the ID(s) 1, . . . , N identify the configuration(s) 1, . . . , N, respectively (e.g., events 306, 390, 406, 405, 407, 490). At block 706, the RAN node transmits, to the UE, a second list including at least one first configuration and at least one first ID of the ID(s) 1, . . . , N to replace at least one second configuration of the configuration(s) 1, . . . , N, where each of the at least one first ID identifies a particular one of the at least one first configuration. At block 708, the RAN node replaces the at least one second configuration with the at least one first target configuration. At block 710, the RAN node transmits, to the UE, a third list including at least one second ID of the ID(s) 1, . . . , N to release at least one of the configuration(s) 1, . . . , N. At block 712, the RAN node releases at least one configuration identified by the at least one second ID.

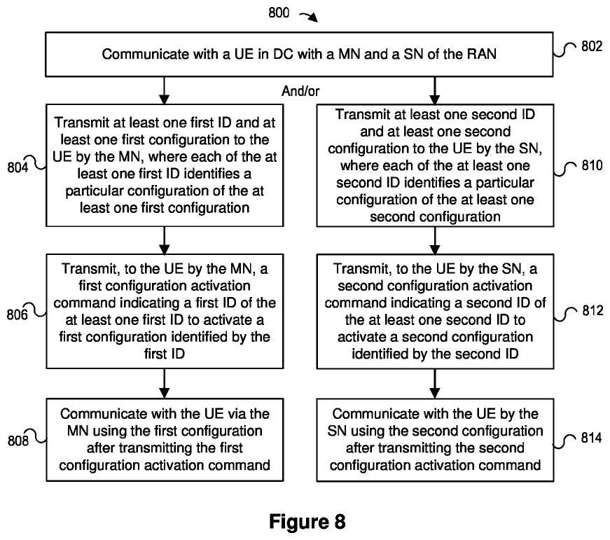

FIG. 8 illustrates a method 800, which can be implemented by a RAN (e.g., the RAN 105), for configuring and activating a serving cell configuration for a UE (e.g., the UE 102).

The method 800 begins at block 802, where the RAN communicates with a UE in DC with an MN and an SN of the RAN (e.g., event 402). The flow can proceed to block 804 and/or block 810. At block 804, the RAN transmits at least one first ID and at least one first configuration to the UE by the MN, where each of the at least one first ID identifies a particular configuration of the at least one first configuration (e.g., events 306, 390, 490). At block 806, the RAN transmits, to the UE by the MN, a first configuration activation command indicating a first ID of the at least one first ID to activate a first configuration identified by the first ID (e.g., events 310, 390, 490). At block 808, the RAN communicates with the UE via the MN using the first configuration after transmitting the first configuration activation command (e.g., events 316, 318, 390, 490).

At block 810, the RAN transmits at least one second ID and at least one second configuration to the UE by the SN, where each of the at least one second ID identifies a particular configuration of the at least one second configuration (e.g., events 406, 405, 407). At block 812, the RAN transmits, to the UE by the SN, a second configuration activation command indicating a second ID of the at least one second ID to activate a second configuration identified by the second ID (e.g., event 410). At block 814, the RAN communicates with the UE by the SN using the second configuration after transmitting the second configuration activation command (e.g., events 416, 418).

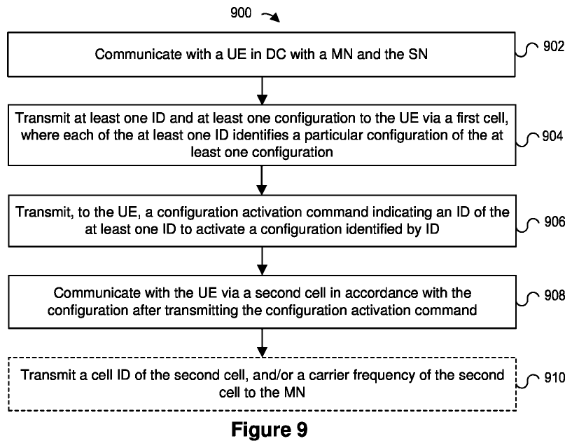

FIG. 9 illustrates a method 900, which can be implemented by an SN (e.g., the base station 104 or 106, DU 174, or CU 172), for configuring and activating a serving cell configuration for a UE (e.g., the UE 102).

The method 900 begins at block 902, where the SN communicates with a UE in DC with an MN and the SN (e.g., event 402). At block 904, the SN transmits at least one ID and at least one configuration to the UE via a first cell, where each of the at least one ID identifies a particular configuration of the at least one configuration (e.g., event 406, 405, 407). At block 906, the SN transmits, to the UE, a configuration activation command indicating an ID of the at least one ID to activate a configuration identified by ID (e.g., event 410). At block 908, the SN communicates with the UE via a second cell in accordance with the configuration after transmitting the configuration activation command (e.g., events 416, 418). In some implementations, at block 910, the SN transmits a cell ID of the second cell, and/or a carrier frequency of the second cell to the MN.

In some implementations, the SN transmits the configuration to the MN. In some implementations, the SN transmits the cell ID of the second cell, carrier frequency, and/or configuration to the MN after transmitting the configuration activation command; receiving, from the UE, an acknowledgement for the configuration activation command (e.g., event 411); or determining that the UE connects to the second cell (e.g., events 416, 418). In some implementations, the SN transmits an SN message (e.g., SN Modification Required message), including the cell ID of the second cell, carrier frequency, and/or configuration, to the MN. Thus, the MN can coordinate, reconfigure, and/or determine radio resource allocations or configurations for the UE based on the cell ID, carrier frequency, and/or configuration. In other implementations, if the configuration, cell ID, and/or carrier frequency does not impact radio resources allocations or configurations that the MN configures for the UE, the SN skips block 910.

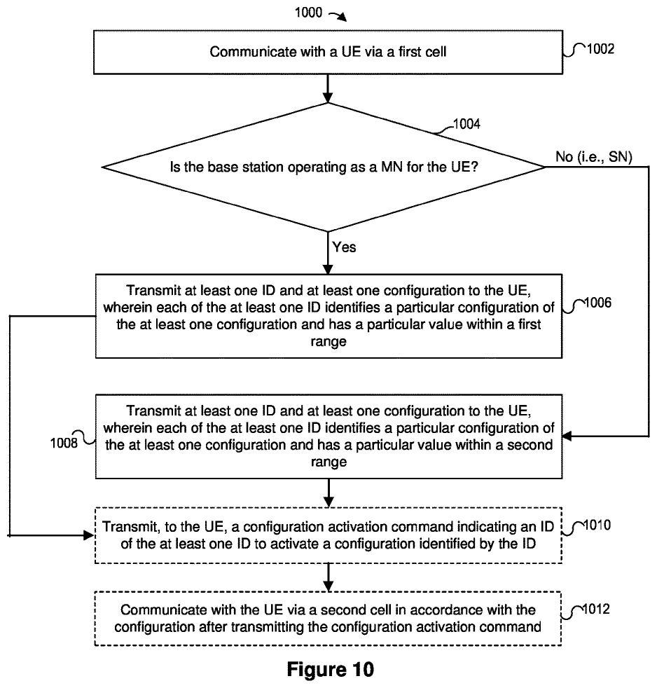

FIG. 10 illustrates a method 1000, which can be implemented by a base station (e.g., the base station 104), for configuring a serving cell configuration for a UE (e.g., the UE 102).

The method 1000 begins at block 1002, where the base station communicates with a UE via a first cell (e.g., events 302, 390, 402, 490). At block 1004, the base station determines whether the base station is operating as an MN for the UE. If the base station is operating as an MN for the UE, the flow proceeds to block 1006. At block 1006, the base station transmits at least one ID and at least one configuration to the UE, where each of the at least one ID identifies a particular configuration of the at least one configuration and has a particular value within a first range (e.g., events 306, 390). Otherwise, if the base station is not operating as an MN for the UE (i.e., the base station is operating as an SN for the UE), the flow proceeds to block 1008. At block 1008, the base station transmits at least one ID and at least one configuration to the UE, where each of the at least one ID identifies a particular configuration of the at least one configuration and has a particular value within a second range (e.g., events 406, 405, 407). The flow proceeds to block 1010 from block 1008 as well as from block 1006. At block 1010, the base station transmits, to the UE, a configuration activation command indicating an ID of the at least one ID to activate a configuration identified by the ID (e.g., events 306, 390 406, 405, 407, 490). At block 1012, the base station communicates with the UE via a second cell in accordance with the configuration after transmitting the configuration activation command (e.g., events 316, 318, 390, 416, 418, 490).

In some implementations, the first range and second range do not overlap. Consequently, the MN and SN do not use the same ID for configuring and activating a serving cell configuration. In further implementations, when the UE receives the configuration activation command, the UE uses an ID in the configuration activation command to identify a particular configuration. This simplifies the UE implementation, because the UE does not need to determine which node (i.e., MN or SN) transmits the configuration activation command.

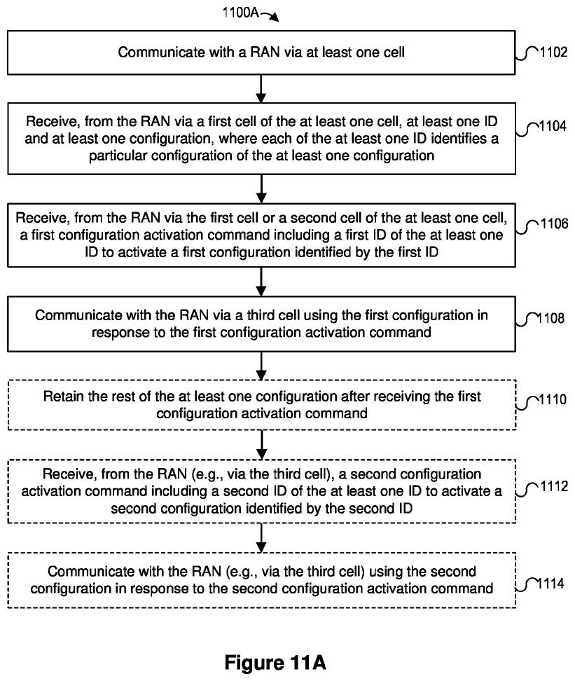

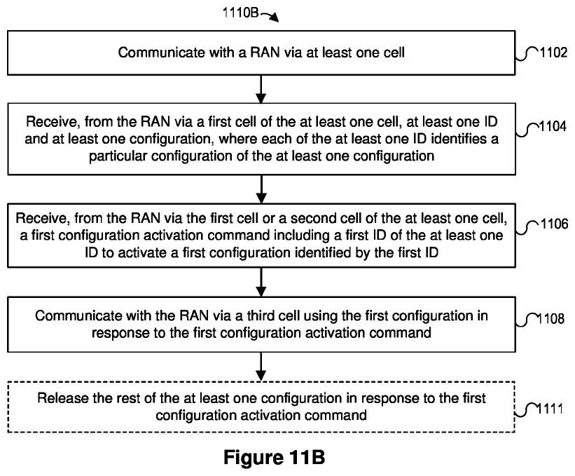

Next, several example methods, implemented in a UE to support configuring a configuration and activating the configuration later, are discussed with reference to FIGS. 11A-16B. Examples and implementations described for FIGS. 3-4B can apply to FIGS. 11A-16B.

FIG. 11A illustrates a method 1100A, which can be implemented by a UE (e.g., the UE 102), for configuring and activating a serving cell configuration with a RAN (e.g., the base station 104/106 or the DU 174).

The method 1100A begins at block 1102, where the UE communicates with the RAN via at least one cell (e.g., events 302, 402). At block 1104, the UE receives, from the RAN via a first cell of the at least one cell, at least one ID and at least one configuration, where each of the at least one ID identifies a particular configuration of the at least one configuration (e.g., events 306, 406, 405, 407). At block 1106, the UE receives, from the RAN via the first cell or a second cell of the at least one cell, a first configuration activation command including a first ID of the at least one ID to activate a first configuration identified by the first ID (e.g., events 310, 390, 410, 490). At block 1108, the UE communicates with the RAN via a third cell using the first configuration in response to the first configuration activation command (e.g., events 316, 318, 416, 418). In some implementations, at block 1110, the UE retains the rest of the at least one configuration after receiving the first configuration activation command. In further implementations, at block 1112, the UE receives, from the RAN (e.g., via the third cell), a second configuration activation command including a second ID of the at least one ID to activate a second configuration identified by the second ID (e.g., events 310, 410, 490). At block 1114, the UE communicates with the RAN (e.g., via the third cell) using the second configuration in response to the second configuration activation command (e.g., events 316, 318, 416, 418).

FIG. 11B is a flow diagram of an example method 1100B similar to the method 1100A, except that method 1100B includes block 1111 instead of blocks 1110, 1112, and 1114. At block 1111, the UE releases the rest of the at least one configuration in response to the first configuration activation command.

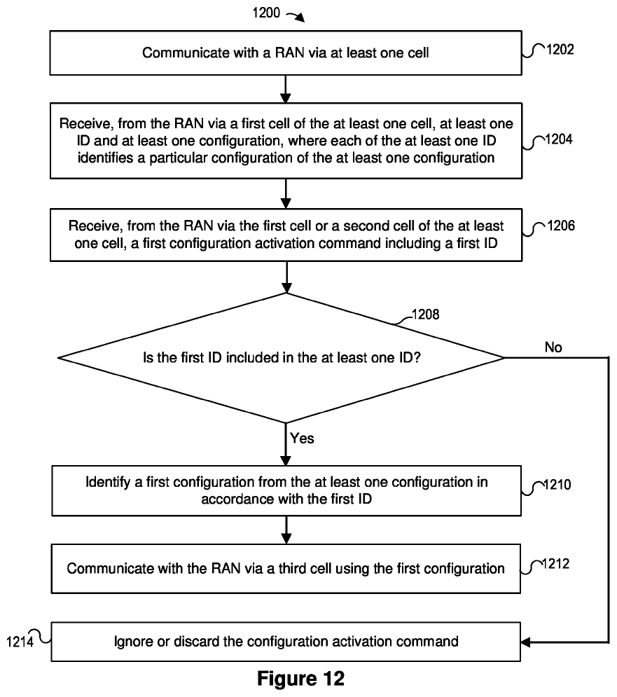

FIG. 12 illustrates a method 1200, which can be implemented by a UE (e.g., the UE 102), for configuring and activating a serving cell configuration with a RAN (e.g., the base station 104/106 or the DU 174).

The method 1200 begins at block 1202, where the UE communicates with the RAN via at least one cell (e.g., events 302, 402). At block 1204, the UE receives, from the RAN via a first cell of the at least one cell, at least one ID and at least one configuration, where each of the at least one ID identifies a particular configuration of the at least one configuration (e.g., events 306, 406, 405, 407). At block 1206, the UE receives, from the RAN via the first cell or a second cell of the at least one cell, a first configuration activation command including a first ID (e.g., events 310, 390, 410, 490). At block 1208, the UE determines whether the first ID is included in the at least one ID. If the first ID is included in the at least one ID, the flow proceeds to block 1210. At block 1210, the UE identifies a first configuration from the at least one configuration in accordance with the first ID. At block 1212, the UE communicates with the RAN via a third cell using the first configuration. Otherwise, if the first ID is not included in the at least one ID, the flow proceeds to block 1214. At block 1214, the UE ignores or discards the configuration activation command. It is an error case when the first ID is not included in the at least one ID. However, the UE refrains from performing an RRC connection reestablishment procedure when the first ID is not included in the at least one ID. Therefore, the UE continues communicating with the RAN via the at least one cell in this case.

In some implementations, the at least one configuration includes the configuration(s) 1, . . . , N described for FIG. 3, 4A, or 4B, and the first configuration 1 described for FIG. 3, 4A, or 4B.

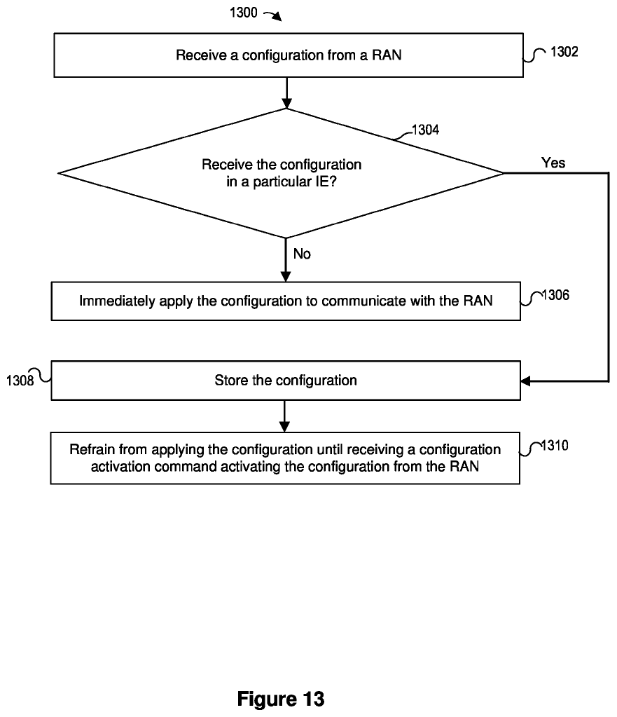

FIG. 13 illustrates a method 1300, which can be implemented by a UE (e.g., the UE 102), for configuring and activating a serving cell configuration with a RAN (e.g., the base station 104/106 or the DU 174).

The method 1300 begins at block 1302, where the UE receives a configuration from the RAN (e.g., events 302, 306, 402, 404, 406, 405, 407). At block 1304, the UE determines whether the UE receives the configuration in a particular IE. If the UE does not receive the configuration in a particular IE, the flow proceeds to block 1306. At block 1306, the UE immediately applies the configuration to communicate with the RAN (e.g., events 302, 402). Otherwise, if the UE receives the configuration in a particular IE, the flow proceeds to block 1308. At block 1308, the UE stores the configuration (e.g., events 306, 406, 405, 407). At block 1310, the UE refrains from applying the configuration until receiving a configuration activation command activating the configuration from the RAN.

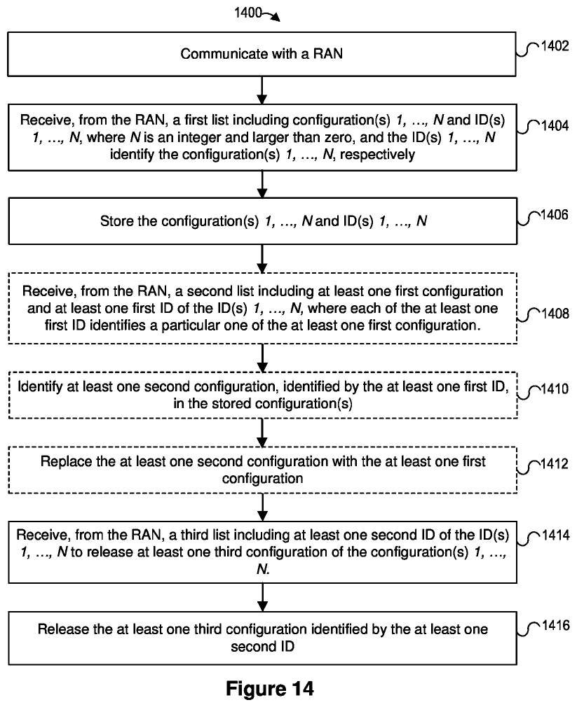

FIG. 14 illustrates a method 1400, which can be implemented by a UE (e.g., the UE 102), for configuring and activating a serving cell configuration with a RAN (e.g., the base station 104/106 or the DU 174).

The method 1400 begins at block 1402, where the UE communicates with the RAN (e.g., events 302, 402). At block 1404, the UE receives, from the RAN, a first list including configuration(s) 1, . . . , N and ID(s) 1, . . . , N, where N is an integer and larger than zero, and the ID(s) 1, . . . , N identify the configuration(s) 1, . . . , N, respectively (e.g., events 306, 406, 405, 407). At block 1406, the UE stores the configuration(s) 1, . . . , N and ID(s) 1, . . . , N. At block 1408, the UE receives, from the RAN, a second list including at least one first configuration and at least one first ID of the ID(s) 1, . . . , N, where each of the at least one first ID identifies a particular one of the at least one first configuration. At block 1410, the UE identifies at least one second configuration, identified by the at least one first ID, in the stored configuration(s) 1, . . . , N. At block 1412, the UE replaces the at least one second configuration with the at least one first configuration. At block 1414, the UE receives, from the RAN, a third list including at least one second ID of the ID(s) 1, . . . , N to release at least one third configuration of the configuration(s) 1, . . . , N. At block 1416, the UE releases at least one third configuration identified by the at least one second ID.

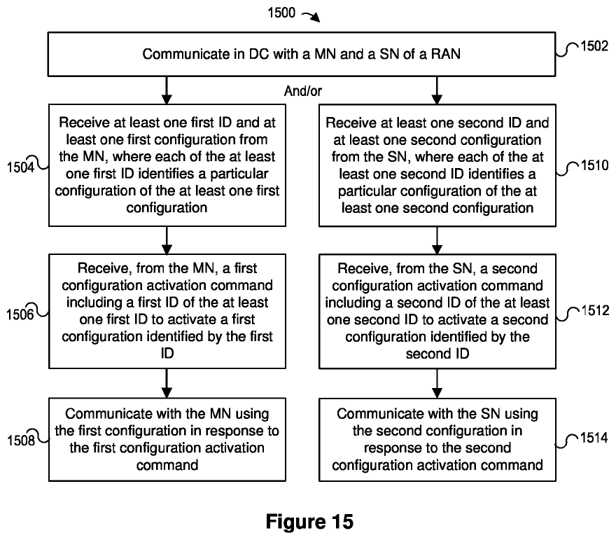

FIG. 15 illustrates a method 1500, which can be implemented by a UE (e.g., the UE 102), for configuring and activating a serving cell configuration with a RAN (e.g., the base station 104/106 or the DU 174).

The method 1500 begins at block 1502, where the UE communicates in DC with an MN and an SN of the RAN (e.g., events 302, 402). The flow can proceed to block 1504 and/or block 1510. At block 1504, the UE receives at least one first ID and at least one first configuration from the MN (e.g., event 306, 390, 490), where each of the at least one first ID identifies a particular configuration of the at least one first configuration. At block 1506, the UE receives, from the MN, a first configuration activation command including a first ID of the at least one first ID to activate a first configuration identified by the first ID (e.g., events 310, 390, 490). At block 1508, the UE communicates with the MN using the first configuration in response to the first configuration activation command (e.g., events 316, 318, 390, 490). At block 1510, the UE receives at least one second ID and at least one second configuration from the SN, where each of the at least one second ID identifies a particular configuration of the at least one second configuration (e.g., events 406, 405, 407). At block 1512, the UE receives, from the SN, a second configuration activation command including a second ID of the at least one second ID to activate a second configuration identified by the second ID (e.g., event 410). At block 1514, the UE communicates with the SN using the second configuration in response to the second configuration activation command (e.g., events 416, 418).

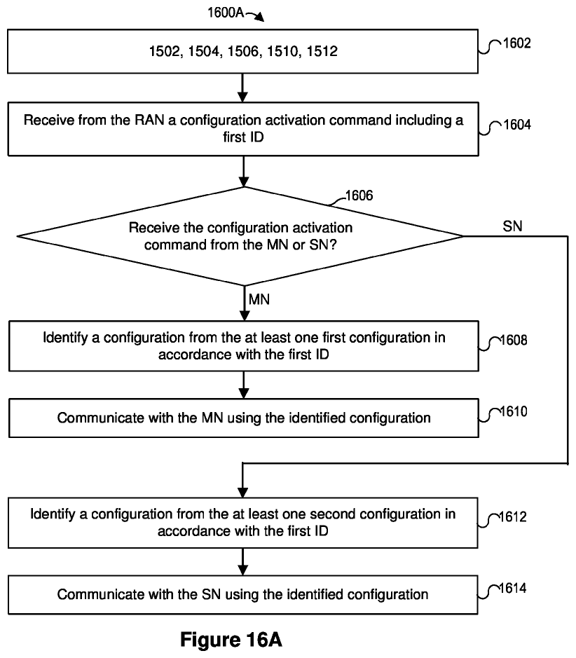

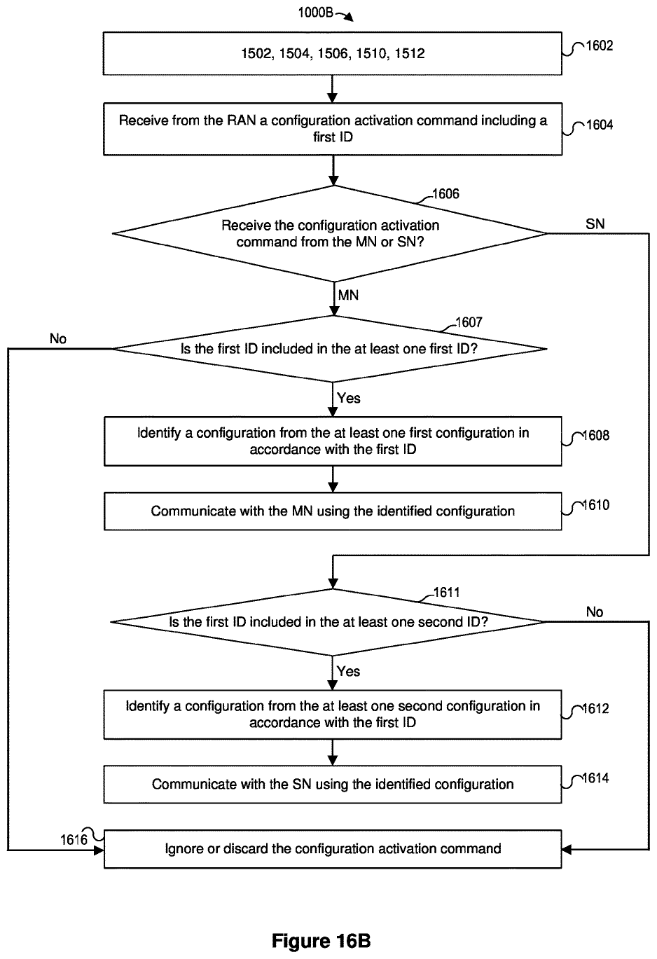

FIG. 16A illustrates a method 1600A, which can be implemented by a UE (e.g., the UE 102), for configuring and activating a serving cell configuration with the RAN (e.g., the base station 104/106 or the DU 174).

The method 1600 begins at block 1602, where the UE starts at blocks 1502, 1504, 1506, 1510, and 1512. At block 1604, the UE receives, from the RAN, a configuration activation command including a first ID (e.g., events 310, 390, 410, 490). At block 1606, the UE determines whether the UE receives the configuration activation command from the MN or SN. If the UE receives the configuration activation command from the MN, the flow proceeds to block 1608. At block 1608, the UE identifies a configuration from the at least one first configuration in accordance with the first ID. At block 1610, the UE communicates with the MN using the identified configuration in response to receiving the configuration activation command (e.g., events 316, 318). Otherwise, if the UE receives the configuration activation command from the SN at block 1606, the flow proceeds to block 1612. At block 1612, the UE identifies a configuration from the at least one second configuration in accordance with the first ID. At block 1614, the UE communicates with the SN using the identified configuration in response to receiving the configuration activation command (e.g., events 416, 418).

FIG. 16B is a flow diagram of an example method 1600B similar to the method 1600A, except that method 1600B includes blocks 1607, 1611, and 1616.

If the UE receives the configuration activation command from the MN at block 1606, the flow proceeds to block 1607. At block 1607, the UE determines whether the first ID is included in the at least one first ID. If the first ID is included in the at least one first ID, the flow proceeds to block 1608. Otherwise, if the first ID is not included in the at least one first ID, the flow proceeds to block 1618. At block 1618, the UE ignores or discards the configuration activation command.

If the UE receives the configuration activation command from the SN at block 1606, the flow proceeds to block 1611. At block 1611, the UE determines whether the first ID is included in the at least one second ID. If the first ID is included in the at least one second ID, the flow proceeds to block 1612. Otherwise, if the first ID is not included in the at least one second ID, the flow proceeds to block 1618.

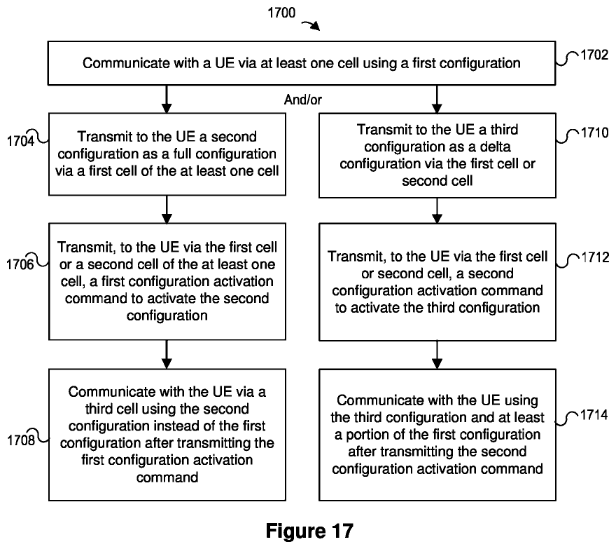

Next, several example methods, implemented in one or more RAN nodes such as base stations, DUs, or CUs, or in a RAN to support configuring a configuration and activating the configuration later, are discussed with reference to FIGS. 17-24. Examples and implementations described for FIGS. 3-4B can apply to FIGS. 17-24.

FIG. 17 illustrates a method 1700, which can be implemented by a RAN node (e.g., the base station 104 or 106, DU 174, or CU 172), for configuring and activating a fast serving cell configuration for a UE (e.g., the UE 102).

The method 1700 begins at block 1702, where the RAN node communicates with the UE via at least one cell using a first configuration (e.g., events 302, 390, 402, 490). The flow can proceed to block 1704 and/or block 1706. At block 1704, the RAN node transmits, to the UE, a second configuration as a full configuration via a first cell of the at least one cell (e.g., events 306, 390, 406, 405, 407, 490). At block 1706, the RAN node transmits, to the UE via the first cell or a second cell of the at least one cell, a first configuration activation command to activate the second configuration (e.g., events 310, 390, 410, 490). At block 1708, the RAN node communicates with the UE via a third cell using the second configuration instead of the first configuration after transmitting the first configuration activation command (e.g., events 316, 318, 390, 416, 418, 490).

At block 1710, the RAN node transmits, to the UE, a third configuration as a delta configuration via the first cell or second cell (e.g., events 306, 390, 406, 405, 407, 490). At block 1712, the RAN node transmits, to the UE via the first cell or the second cell, a second configuration activation command to activate the third configuration (e.g., events 310, 390, 410, 490). At block 1714, the RAN node communicates with the UE using the third configuration and at least a portion of the first configuration after transmitting the second configuration activation command (e.g., events 316, 318, 390, 416, 418, 490).

In some implementations, the RAN node transmits an RRC message, including the second configuration and third configuration, to the UE (e.g., events 306, 390, 406, 405, 407, 490). In other implementations, the RAN node transmits a first RRC message, including the second configuration, to the UE (e.g., events 306, 390, 406, 405, 407, 490) and transmits a second RRC message, including the third configuration, to the UE. In some implementations, the first and second RRC messages are RRC reconfiguration messages. In some implementations, one of the second configuration and third configuration is the configuration 1 and the other is one of the configuration(s) 2, . . . , N described for FIG. 3, 4A, or 4B.

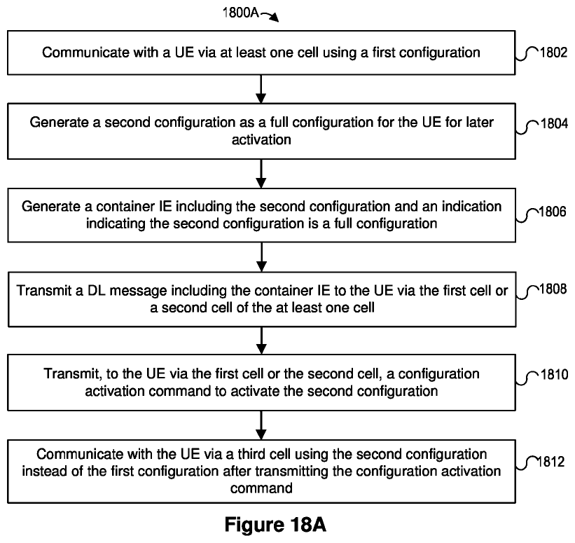

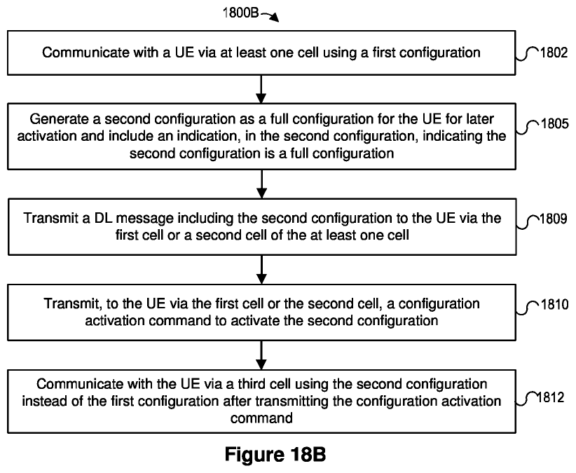

FIG. 18A illustrates a method 1800A, which can be implemented by a RAN node (e.g., the base station 104 or 106, DU 174, or CU 172), for configuring and activating a fast serving cell configuration for a UE (e.g., the UE 102).

The method 1800A begins at block 1802, where the RAN node communicates with the UE via at least one cell using a first configuration (e.g., events 302, 390, 402, 490). At block 1804, the RAN node generates a second configuration as a full configuration for the UE for later activation. At block 1806, the RAN node generates a container IE including the second configuration and an indication that the second configuration is a full configuration. At block 1808, the RAN node transmits a DL message, including the container IE, to the UE via the first cell or a second cell of the at least one cell (e.g., events 306, 390, 406, 405, 407, 490). At block 1810, the RAN node transmits, to the UE via the first cell or the second cell, a configuration activation command to activate the second configuration (e.g., events 310, 390, 410, 490). At block 1812, the RAN node communicates with the UE via a third cell using the second configuration instead of the first configuration after transmitting the configuration activation command (e.g., events 316, 318, 390, 416, 418, 490).

In some implementations, the second configuration is a CellGroupConfig IE and the indication is a field or IE newly defined (e.g., in 3GPP specification 38.331 v18.0.0 or later version). The field or IE is different from the fullConfig field (e.g., defined in existing 3GPP specification 38.331 (e.g., v15.7.0)).

FIG. 18B is a flow diagram of an example method 1800B similar to the method 1800A, except that method 1800B includes blocks 1805 and 1809 instead of blocks 1804, 1806, and 1808. At block 1805, the RAN node generates a second configuration as a full configuration for the UE for later activation and includes an indication, in the second configuration, indicating the second configuration is a full configuration. At block 1809, the RAN node transmits a DL message, including the second configuration, to the UE via the first cell or a second cell of the at least one cell (e.g., events 306, 390, 406, 405, 407, 490).

In some implementations, the second configuration is an RRCReconfiguration-IEs IE and the indication, which is excluded, is a fullConfig field.

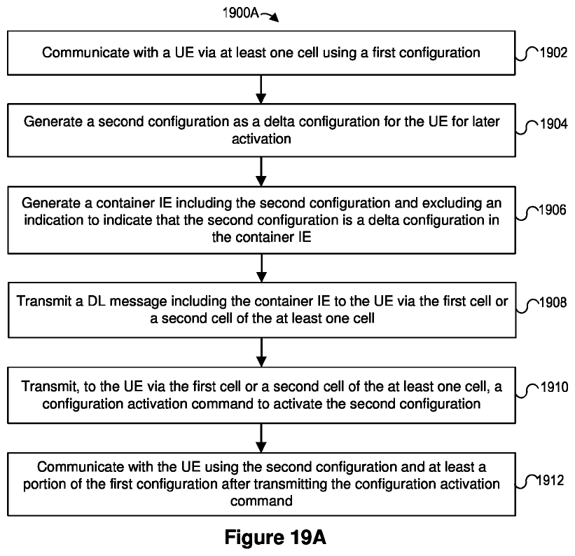

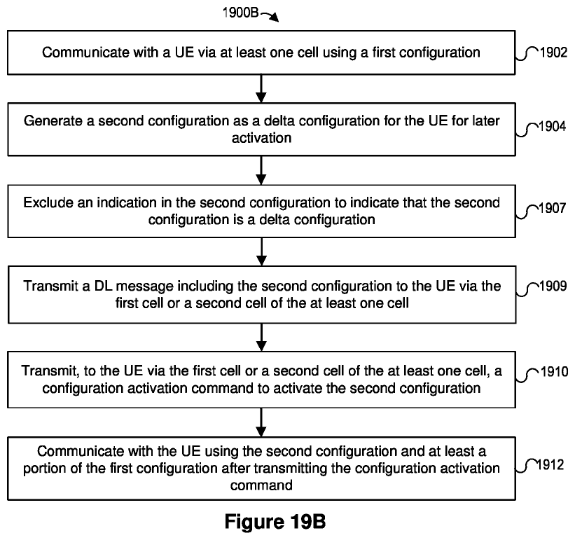

FIG. 19A illustrates a method 1900A, which can be implemented by a RAN node (e.g., the base station 104 or 106, DU 174, or CU 172), for configuring and activating a fast serving cell configuration for a UE (e.g., the UE 102).

The method 1900A begins at block 1902, where the RAN node communicates with the UE via at least one cell using a first configuration (e.g., events 302, 390, 402, 490). At block 1904, the RAN node generates a second configuration as a full configuration for the UE for later activation. At block 1906, the RAN node generates a container IE including the second configuration and excluding an indication that the second configuration is a delta configuration in the container IE. At block 1908, the RAN node transmits a DL message including the container IE to the UE via the first cell or a second cell of the at least one cell (e.g., events 306, 390, 406, 405, 407, 490). At block 1910, the RAN node transmits, to the UE via the first cell or a second cell of the at least one cell, a configuration activation command to activate the second configuration (e.g., events 310, 390, 410, 490). At block 1912, the RAN node communicates with the UE using the second configuration and at least a portion of the first configuration after transmitting the configuration activation command (e.g., events 316, 318, 390, 416, 418, 490).

FIG. 19B is a flow diagram of an example method 1900B similar to the method 1900A, except that method 1900B includes blocks 1907 and 1909 instead of blocks 1906 and 1908. At block 1907, the RAN node excludes an indication in the second configuration to indicate that the second configuration is a delta configuration. At block 1909, the RAN node transmits a DL message, including the second configuration, to the UE via the first cell or a second cell of the at least one cell (e.g., events 306, 390, 406, 405, 407, 490).

Implementations described for FIGS. 18A and 18B can apply to FIGS. 19A and 19B, respectively.

FIG. 20 illustrates a method 2000, which can be implemented by a RAN node (e.g., the base station 104 or 106, DU 174, or CU 172), for configuring and activating a fast serving cell configuration for a UE (e.g., the UE 102).

The method 2000 begins at block 2002, where the RAN node communicates with the UE via at least one cell using a first configuration (e.g., events 302, 390, 402, 490). At block 2004, the RAN node determines to generate a second configuration for later activation for the UE. At block 2006, the RAN node determines whether the second configuration is to replace the first configuration. If the second configuration is to replace the first configuration, the flow proceeds to block 2008. At block 2008, the RAN node generates the second configuration as a full configuration to replace the first configuration. Otherwise, if the second configuration is not to replace the first configuration, the flow proceeds to block 2010. At block 2010, the RAN node generates the second configuration as a delta configuration to augment the first configuration. At block 2012, the RAN node transmits the second configuration to the UE via a first cell of the at least one cell (e.g., events 306, 390, 406, 405, 407, 490). The flow proceeds to block 2012 from block 2010 as well as from block 2008. At block 2014, the RAN node transmits a configuration activation command to the UE via the first cell or a second cell of the at least one cell to activate the second configuration (e.g., events 310, 390, 410, 490).

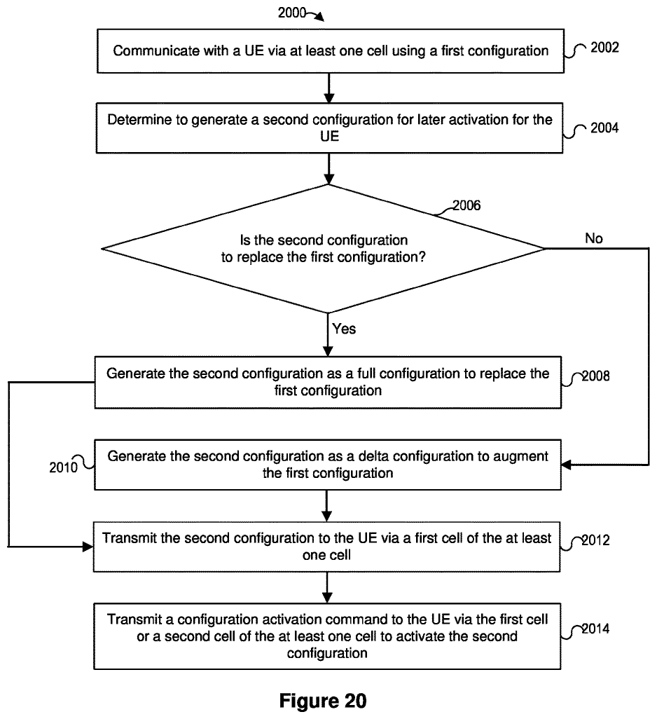

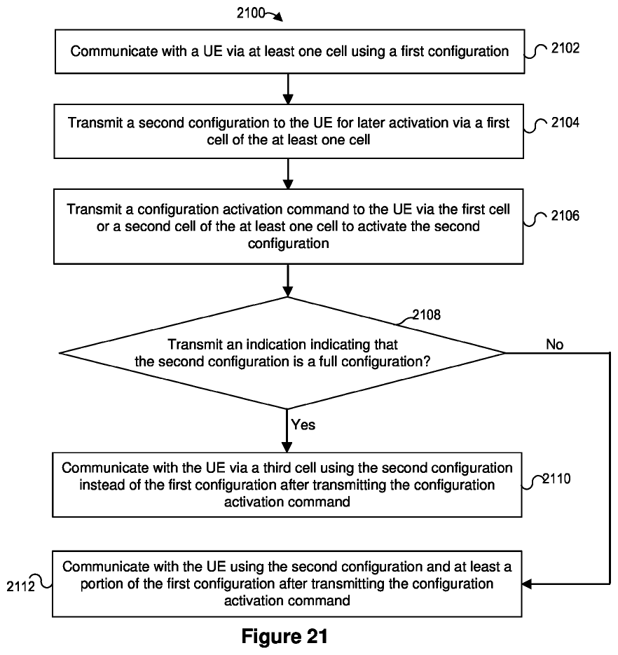

FIG. 21 illustrates a method 2100, which can be implemented by a RAN node (e.g., the base station 104 or 106, DU 174, or CU 172), for configuring and activating a fast serving cell configuration for a UE (e.g., the UE 102).

The method 2100 begins at block 2102, where the RAN node communicates with the UE via at least one cell using a first configuration (e.g., events 302, 390, 402, 490). At block 2104, the RAN node transmits a second configuration to the UE for later activation via a first cell of the at least one cell (e.g., events 306, 390, 406, 405, 407, 490). At block 2106, the RAN node transmits a configuration activation command to the UE via the first cell or a second cell of the at least one cell to activate the second configuration (e.g., events 310, 390, 410, 490). At block 2108, the RAN node determines whether the RAN node transmits an indication that the second configuration is a full configuration. If the RAN node transmits an indication that the second configuration is a full configuration, the flow proceeds to block 2110. At block 2110, the RAN node communicates with the UE via a third cell using the second configuration instead of the first configuration after transmitting the configuration activation command (e.g., events 316, 318, 390, 416, 418, 490). Otherwise, if the RAN node does not transmit an indication that the second configuration is a full configuration (i.e., the second configuration is a delta configuration), the flow proceeds to block 2112. At block 2112, the RAN node communicates with the UE using the second configuration and at least a portion of the first configuration after transmitting the configuration activation command (e.g., events 316, 318, 390, 416, 418, 490).

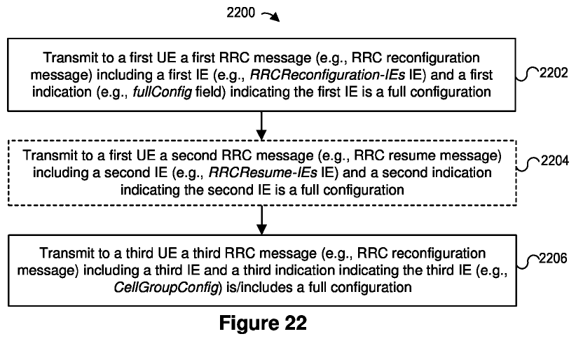

FIG. 22 illustrates a method 2200, which can be implemented by a RAN node (e.g., the base station 104 or 106, DU 174, or CU 172), for configuring a full configuration for a UE (e.g., the UE 102).

The method 2200 begins at block 2202, where the RAN node transmits, to a first UE, a first RRC message (e.g., RRC reconfiguration message) including a first IE (e.g., RRCReconfiguration-IEs IE) and a first indication (e.g., fullConfig field) indicating that the first IE is a full configuration (e.g., events 306, 406, 405, 407). In some implementations, at block 2204, the RAN node transmits, to a first UE, a second RRC message (e.g., RRC resume message) including a second IE (e.g., RRCResume-IEs IE) and a second indication that the first IE is a full configuration. At block 2206, the RAN node transmits, to a third UE, a third RRC message (e.g., RRC reconfiguration message) including a third IE and a third indication that the third IE (e.g., CellGroupConfig IE) is a full configuration (e.g., events 306, 390, 406, 405, 407, 490).

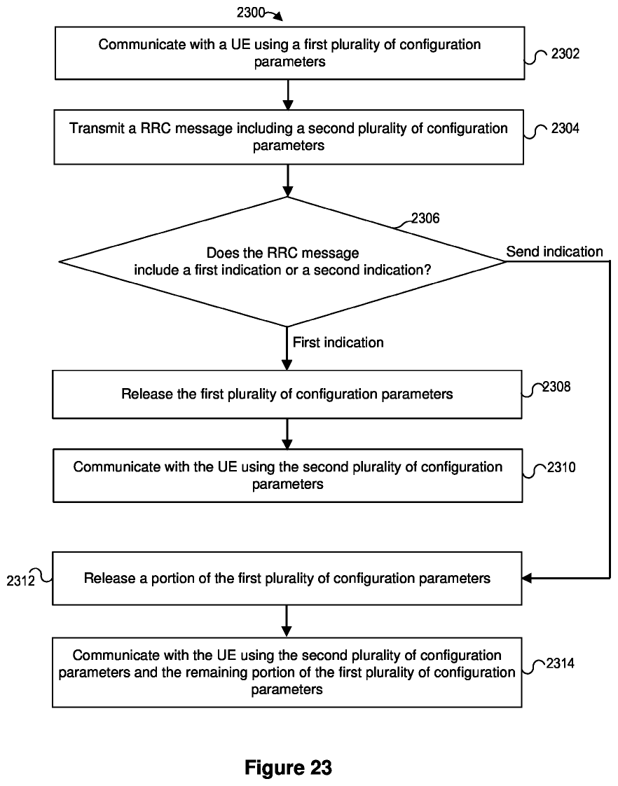

FIG. 23 illustrates a method 2300, which can be implemented by a RAN node (e.g., the base station 104 or 106, DU 174, or CU 172), for different full configurations for a UE (e.g., the UE 102).

The method 2300 begins at block 2302, where the RAN node communicates with the UE using a first plurality of configuration parameters. At block 2304, the RAN node transmits an RRC message including a second plurality of configuration parameters (e.g., events 306, 390, 406, 405, 407, 490). At block 2306, the RAN node determines whether the RRC message includes a first indication or a second indication. If the RRC message includes a first indication, the flow proceeds to block 2308. At block 2308, the RAN node releases the first plurality of configuration parameters. At block 2310, the RAN node communicates with the UE using the second plurality of configuration parameters. Otherwise, if the RRC message includes a second indication, the flow proceeds to block 2312. At block 2312, the RAN node releases a portion of the first plurality of configuration parameters. At block 2314, the RAN node communicates with the UE using the second plurality of configuration parameters and the remaining portion of the first plurality of configuration parameters (e.g., events 318, 390, 418, 490).

In some implementations, the first indication is a fullConfig field (e.g., defined in 3GPP specification 38.331 v15.9.0 and later versions), and the second indication is a new field or IE (e.g., defined in a 3GPP specification 38.331 v18.0.0 and/or later versions). In some implementations, the second indication is a lower layer full configuration indication. In some implementations, the first plurality of configuration parameters includes a radio bearer configuration (e.g., RadioBearerConfig), measurement configuration(s) (e.g., MeasConfig 1E(s)), and/or a cell group configuration (e.g., CellGroupConfig), or includes configuration parameters in the radio bearer configuration, measurement configuration(s), cell group configuration, and/or other configuration. In some implementations, the second plurality of configuration parameters includes a radio bearer configuration (e.g., RadioBearerConfig IE), measurement configuration(s) (e.g., MeasConfig IE(s)), a cell group configuration (e.g., CellGroupConfig IE), and/or other configuration (e.g., OtherConfig IE), or includes configuration parameters in the radio bearer configuration, measurement configuration(s), cell group configuration, and/or other configuration. In other implementations, the second plurality of configuration parameters does not include a radio bearer configuration (e.g., RadioBearerConfig), measurement configuration(s) (e.g., MeasConfig IE(s)), and/or other configuration (e.g., OtherConfig IE).

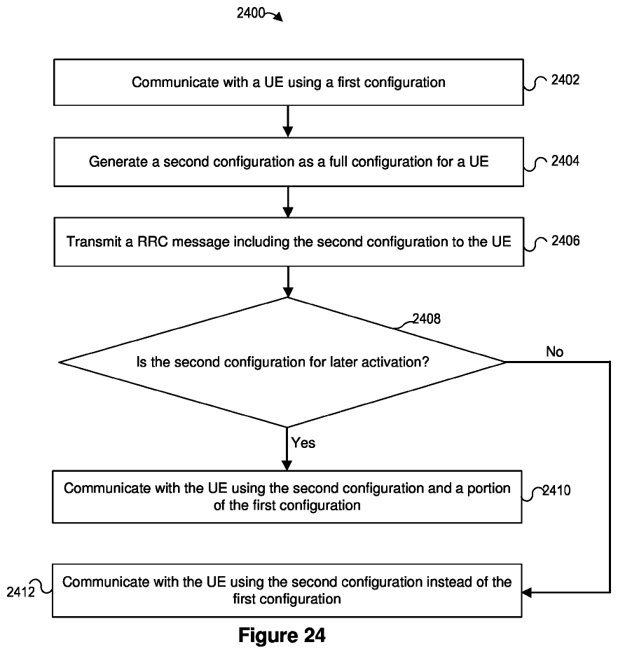

FIG. 24 illustrates a method 2400, which can be implemented by a RAN node (e.g., the base station 104 or 106, DU 174, or CU 172), for configuring and activating a fast serving cell configuration for a UE (e.g., the UE 102).

The method 2400 begins at block 2402, where the RAN node communicates with a UE using a first configuration (e.g., event 302, 402). At block 2404, the RAN node generates a second configuration as a full configuration for a UE. At block 2406, the RAN node transmits an RRC message, including the second configuration, to the UE (e.g., events 306, 406, 405, 407). At block 2408, the RAN node determines whether the second configuration is for later activation. If the second configuration is for later activation, the flow proceeds to block 2410. At block 2410, the RAN node communicates with the UE using the second configuration and a portion of the first configuration (e.g., events 318, 418). Otherwise, if the second configuration is not for later activation, the flow proceeds to block 2412. At block 2412, the RAN node communicates with the UE using the second configuration instead of the first configuration (e.g., events 318, 418).

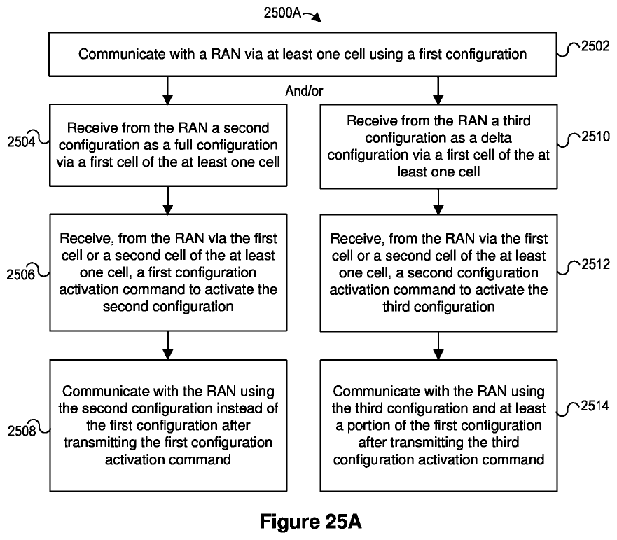

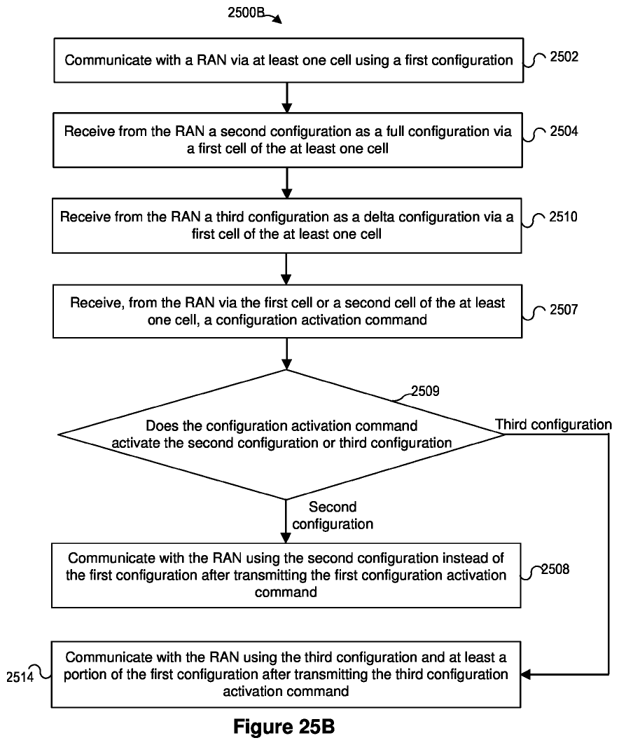

Next, several example methods, implemented in a UE to support configuring a configuration and activating the configuration later, are discussed with reference to FIGS. 25A-29. Examples and implementations described for FIGS. 3-4B can apply to FIGS. 25A-29.

FIG. 25A illustrates a method 2500A, which can be implemented by a UE (e.g., the UE 102), for configuring and activating a serving cell configuration with a RAN (e.g., the base station 104/106 or the DU 174).

The method 2500A begins at block 2502, where the UE communicates with a RAN via at least one cell using a first configuration (e.g., events 302, 390, 402, 490). The flow can proceed to block 2504 and/or block 2510. At block 2504, the UE receives, from the RAN, a second configuration as a full configuration via a first cell of the at least one cell (e.g., events 306, 390, 406, 405, 407, 490). At block 2506, the UE receives, from the RAN via the first cell or a second cell of the at least one cell, a first configuration activation command to activate the second configuration (e.g., events 312, 390, 410, 490). At block 2508, the UE communicates with the RAN using the second configuration instead of the first configuration after transmitting the first configuration activation command (e.g., events 316, 318, 390, 416, 418, 490). In some implementations, the second configuration configures a third cell, and the UE at block 2508 communicates with the RAN on the third cell. In some implementations, the UE disconnects from the first cell in response to or in accordance with the second configuration and/or first configuration activation command. In some implementations, the first cell and the third cell are a PCell and a new or target PCell, respectively. In other implementations, the first cell and the third cell are a PSCell and a new or target PSCell, respectively. In yet further implementation, the first cell and the third cell are an SCell and a new or target SCell, respectively.

At block 2510, the UE receives, from the RAN, a third configuration as a delta configuration via a first cell of the at least one cell (e.g., events 302, 390, 402, 490). At block 2512, the UE receives, from the RAN via the first cell or a second cell of the at least one cell, a second configuration activation command to activate the third configuration (e.g., events 306, 390, 406, 405, 407, 490). At block 2514, the UE communicates with the RAN using the third configuration and at least a portion of the first configuration after transmitting the third configuration activation command (e.g., events 316, 318, 390, 416, 418, 490). In some implementations, the third configuration configures a fourth cell, and the UE at block 2514 communicates with the RAN on the fourth cell. In some implementations, the UE disconnects from the first cell in response to or in accordance with the third configuration and/or second configuration activation command. In some implementations, the first cell and the fourth cell are a PCell and a new or target PCell, respectively. In other implementations, the first cell and the fourth cell are a PSCell and a new or target PSCell, respectively. In yet further implementations, the first cell and the fourth cell are an SCell and a new or target SCell, respectively.

In some implementations, the UE receives an RRC message, including the second configuration and third configuration, from the RAN (e.g., events 306, 390, 406, 405, 407, 490). In other implementations, the UE receives a first RRC message, including the second configuration, from the RAN (e.g., events 306, 390, 406, 405, 407, 490) and receives a second RRC message, including the third configuration, from the RAN. In some implementations, the first and second RRC messages are RRC reconfiguration messages. In some implementations, one of the second configuration and third configuration is the configuration 1 and the other is one of the configuration(s) 2, . . . , N described for FIG. 3, 4A, or 4B.

FIG. 25B is a flow diagram of an example method 2500B similar to the method 2500A, except that method 2500B includes blocks 2507 and 2509 instead of blocks 2506 and 2512. At block 2507, the UE receives, from the RAN via the first cell or a second cell of the at least one cell, a configuration activation command (e.g., events 310, 390, 410, 490). At block 2509, the UE determines whether the configuration activation command activates the second configuration or third configuration. If the UE determines that the configuration activation command activates the second configuration at block 2509, the flow proceeds to block 2512. Otherwise, if the UE determines that the configuration activation command activates the third configuration at block 2509, the flow proceeds to block 2514.

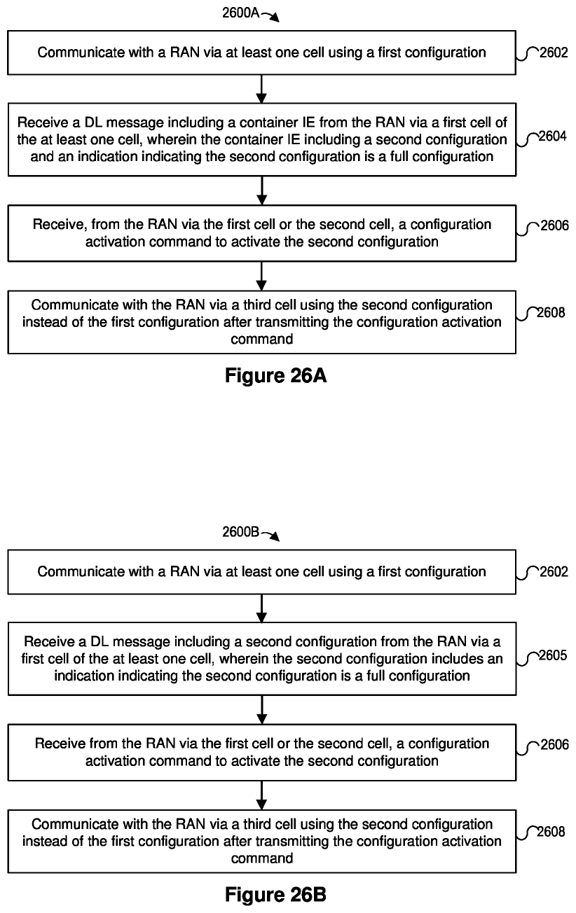

FIG. 26A illustrates a method 2600A, which can be implemented by a UE (e.g., the UE 102), for configuring and activating a serving cell configuration with a RAN (e.g., the base station 104/106 or the DU 174).

The method 2600A begins at block 2602, where the UE communicates with a RAN via at least one cell using a first configuration (e.g., events 302, 390, 402, 490). At block 2604, the UE receives a DL message, including a container IE, from the RAN via a first cell of the at least one cell, where the container IE includes a second configuration and an indication that the second configuration is a full configuration (e.g., events 306, 390, 406, 405, 407, 490). At block 2606, the UE receives, from the RAN via the first cell or the second cell, a configuration activation command to activate the second configuration (e.g., events 310, 390, 410, 490). At block 2608, the UE communicates with the RAN via a third cell using the second configuration instead of the first configuration after receiving the configuration activation command (e.g., events 316, 318, 390, 416, 418, 490).

In some implementations, the second configuration is a CellGroupConfig IE, and the indication is a new field or IE (e.g., newly defined in 3GPP specification 38.331 v18.0.0 or later version). The field or IE is different from the fullConfig field (e.g., defined in existing 3GPP specification 38.331 (e.g., v15.7.0)).

FIG. 26B is a flow diagram of an example method 2600B similar to the method 2600A, except that method 2600B includes block 2605 instead of block 2604. At block 2605, the UE receives a DL message, including a second configuration, from the RAN via a first cell of the at least one cell, where the second configuration includes an indication that the second configuration is a full configuration (e.g., events 306, 390, 406, 405, 407, 490).

In some implementations, the second configuration is an RRCReconfiguration-IEs IE, and the indication is a fullConfig field.

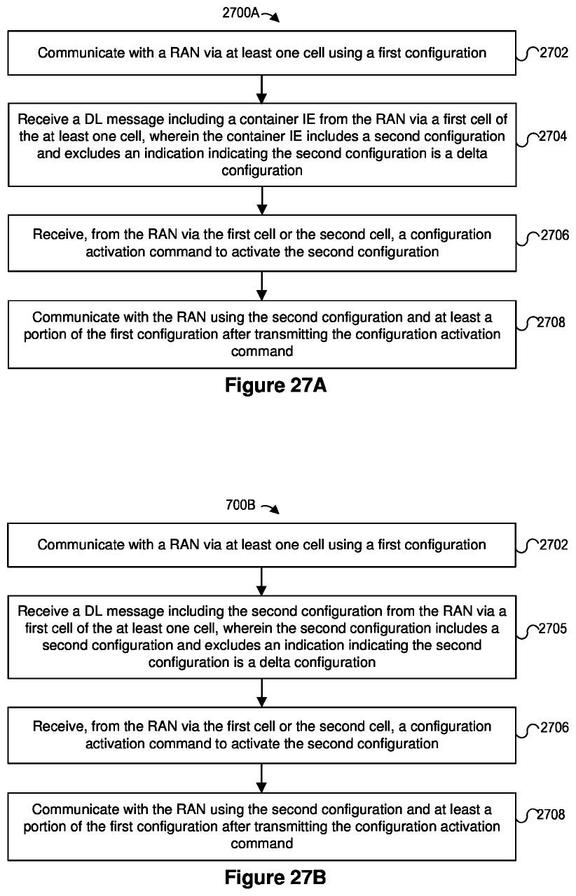

FIG. 27A illustrates a method 2700A, which can be implemented by a UE (e.g., the UE 102), for configuring and activating a serving cell configuration with a RAN (e.g., the base station 104/106 or the DU 174).

The method 2700A begins at block 2702, where the UE communicates with a RAN via at least one cell using a first configuration (e.g., events 302, 390, 402, 490). At block 2704, the UE receives a DL message, including a container IE, from the RAN via a first cell of the at least one cell, where the container IE includes a second configuration and excludes an indication that the second configuration is a delta configuration (e.g., events 306, 390, 406, 405, 407, 490). At block 2706, the UE receives, from the RAN via the first cell or the second cell, a configuration activation command to activate the second configuration (e.g., events 310, 390, 410, 490). At block 2708, the UE communicates with the RAN using the second configuration and at least a portion of the first configuration after receiving the configuration activation command (e.g., events 316, 318, 390, 416, 418, 490).

FIG. 27B is a flow diagram of an example method 2700B similar to the method 2700A, except that method 2700B includes block 2705 instead of block 2704. At block 2705, the UE receives a DL message, including the second configuration, from the RAN via a first cell of the at least one cell, where the second configuration includes a second configuration and excludes an indication that the second configuration is a delta configuration (e.g., events 306, 390, 406, 405, 407, 490).

Implementations described for FIGS. 26A and 26B can apply to FIGS. 27A and 27B, respectively.

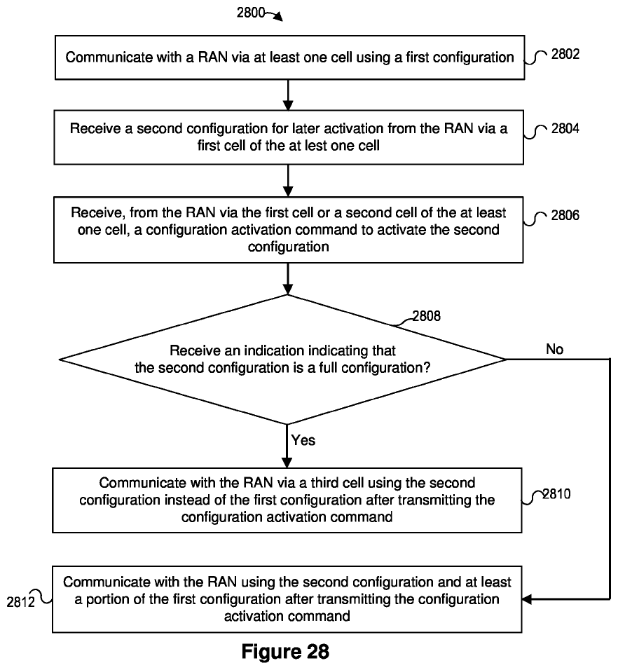

FIG. 28 illustrates a method 2800, which can be implemented by a UE (e.g., the UE 102), for configuring and activating a serving cell configuration with a RAN (e.g., the base station 104/106 or the DU 174).

The method 2800 begins at block 2802, where the UE communicates with a RAN via at least one cell using a first configuration (e.g., events 302, 390, 402, 490). At block 2804, the UE receives a second configuration for later activation from the RAN via a first cell of the at least one cell (e.g., events 306, 390, 406, 405, 407, 490). At block 2806, the UE receives, from the RAN via the first cell or a second cell of the at least one cell, a configuration activation command to activate the second configuration (e.g., 310, 390, 410, 490). At block 2808, the UE determines whether the UE receives an indication that the second configuration is a full configuration. If the UE receives an indication that the second configuration is a full configuration, the flow proceeds to block 2810. At block 2810, the UE communicates with the RAN via a third cell using the second configuration instead of the first configuration after receiving the configuration activation command (e.g., events 318, 390, 418, 490). Otherwise, if the UE does not receive an indication that the second configuration is a full configuration (i.e., the second configuration is a delta configuration), the flow proceeds to block 2812. At block 2812, the UE communicates with the RAN using the second configuration and at least a portion of the first configuration after receiving the configuration activation command (e.g., events 318, 390, 418, 490).

Implementations described for FIGS. 26A-27B can apply to FIG. 28.

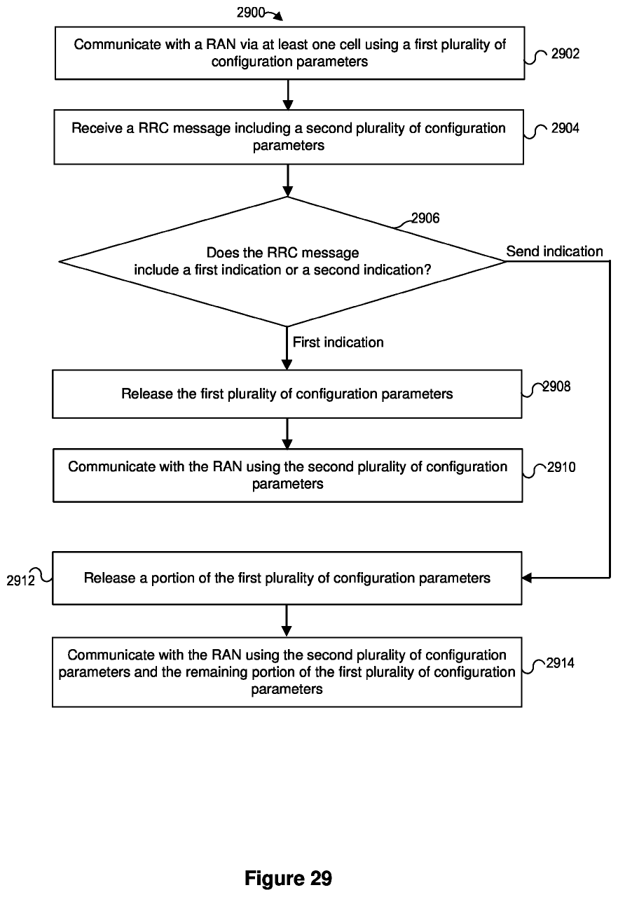

FIG. 29 illustrates a method 2900, which can be implemented by a UE (e.g., the UE 102), for configuring and activating a fast serving cell configuration with a RAN (e.g., the base station 104/106 or the DU 174).

The method 2900 begins at block 2902, where the UE communicates with a RAN via at least one cell using a first plurality of configuration parameters (e.g., events 302, 390, 402, 490). At block 2904, the UE receives an RRC message including a second plurality of configuration parameters (e.g., events 306, 390, 406, 405, 407, 490). At block 2906, the UE determines whether the RRC message includes a first indication or a second indication. If the RRC message includes a first indication, the flow proceeds to block 2908. At block 2908, the UE releases the first plurality of configuration parameters. At block 2910, the UE communicates with the RAN using the second plurality of configuration parameters. Otherwise, if the RRC message includes a second indication, the flow proceeds to block 2912. At block 2912, the UE releases a portion of the first plurality of configuration parameters. At block 2914, the UE communicates with the RAN using the second plurality of configuration parameters and the remaining portion of the first plurality of configuration parameters.

In some implementations, the first indication is a fullConfig field, and the second indication is a field or IE newly defined (e.g., in 3GPP specification 38.331 v18.0.0 or later version). The field or IE is different from the fullConfig field (e.g., defined in existing 3GPP specification 38.331 (e.g., v15.7.0)). In some implementations, the RRC message is an RRCReconfiguration message or an RRCResume message.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “configuration activation command” can be replaced by “serving cell change command”, “Layer 1/Layer 2 switching command”, “lower layer switching command” or “lower layer serving cell change command”. The “fast serving cell configuration procedure” can be replaced by “fast serving cell change procedure”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a user equipment (UE), the method comprising:
communicating with a radio access network (RAN) according to a first configuration, including using an radio link control (RLC) entity;
receiving, from the RAN, a second configuration for use subsequent to receiving an activation command;
receiving the activation command from the RAN; and
in response to the activation command:
using the second configuration to communicate with the RAN, including determining whether to reestablish the RLC entity in accordance with an indication from the RAN.

2. The method of claim 1, wherein the determining whether to reestablish the RLC entity includes is based on whether the second configuration includes an RLC reestablishment indication.

3. The method of claim 1, further comprising:
reestablishing the RLC entity prior to performing a random access procedure in accordance with the second configuration.

4. The method of claim 1, further comprising:
reestablishing the RLC entity subsequent to performing a random access procedure in accordance with the second configuration.

5. The method of claim 1, further comprising:
reestablishing the RLC entity, including discarding one or more of:
an RLC service data units (SDU) s,
an RLC SDU segment, or
an RLC protocol data unit (PDU).

6. The method of claim 1, further comprising:
resetting a timer associated with the RLC entity.

7. The method of claim 1, further comprising:
resetting a state variable associated with the RLC entity to an initial value.

8. The method of claim 2, further comprising:
refraining from reestablishing the RLC entity in response to determining that the second configuration omits the RLC reestablishment indication.

9. The method of claim 1, wherein the determining whether to reestablish the RLC entity is further based on whether the UE is configured to reestablish the RLC entity.

10. The method of claim 1, wherein:
the second configuration includes a fast serving cell configuration, and
the activation command is based on a lower layer measurement report from the UE.

11. A user equipment (UE) comprising:
a transceiver; and
processing hardware, the UE configured to;
communicate with a radio access network (RAN) according to a first configuration, including using a radio link control (RLC) entity;
receive, from the RAN, a second configuration for use subsequent to receiving an activation command;
receive the activation command from the RAN, and
in response to the activation command:
use the second configuration to communicate with the RAN, including determine whether to reestablish the RLC entity in accordance with an indication from the RAN.

12. A method implemented in a radio access network (RAN) node, the method comprising:
communicating with a user equipment (UE) in accordance with a first configuration;
generating a second configuration, including refraining from including a reestablishment indication for a radio link control (RLC) bearer in the second configuration, when the second configuration is to be activated at the UE via a command from the RAN; and
transmitting, to the UE, the second configuration.

13. The method of claim 12, further comprising:
transmitting, to the UE and subsequent to the transmitting of the second configuration, an activation command; and
communicating with the UE in accordance with the second configuration and using the RLC bearer.

14. The method of claim 12, wherein:
the RAN node is a distributed unit (DU) of a distributed base station;
the method further comprising:
transmitting the second configuration to the CU; and
receiving, from the CU, a radio resource control (RRC) message addressed to the UE, the RRC message including the second configuration.

15. (canceled)

16. The UE of claim 11, wherein the determining whether to reestablish the RLC entity includes is based on whether the second configuration includes an RLC reestablishment indication.

17. The UE of claim 11, further configured to:
reestablish the RLC entity prior to performing a random access procedure in accordance with the second configuration.

18. The UE of claim 11, further configured to:
reestablish the RLC entity subsequent to performing a random access procedure in accordance with the second configuration.

19. The UE of claim 11, further configured to:
reestablish the RLC entity, including discard one or more of:
an RLC service data units (SDU) s,
an RLC SDU segment, or
an RLC protocol data unit (PDU).

20. The UE of claim 11, further configured to:
reset a timer associated with the RLC entity.

21. The UE of claim 11, further configured to:
reset a state variable associated with the RLC entity to an initial value.
